(19) United States
(12) Patent Application Publication
(10) Pub. No.: US 2026/0128955 A1
(43) Pub. Date: May 7, 2026

(54) AUTOMATIC DEPLOYMENT SYSTEM AND METHOD THEREOF

(71) Applicant: FAR EASTONE TELECOMMUNICATIONS CO., LTD., Taipei City (TW)

(72) Inventors: Li-Hsiang SHEN, Hsinchu City (TW); Po-Chen WU, New Taipei City (TW); Kai-Ten FENG, Hsinchu City (TW); Chun-Chieh KUO, New Taipei City (TW); Hua-Pei CHIANG, TAIPEI CITY (TW); Chyi-Dar JANG, TAIPEI CITY (TW); Chi-Hung LIN, New Taipei City (TW); Che-Yu LIAO, Taipei City (TW); Wei-Di HUANG, Taipei City (TW); Tung-Min YANG, New Taipei City (TW); Ming-Wei LI, New Taipei City (TW)

(21) Appl. No.: 18/989,497

(22) Filed: Dec. 20, 2024

(30) Foreign Application Priority Data
Nov. 5, 2024 (TW) 113142381

(51) Int. Cl. H04L 41/147; H04L 41/16

(52) U.S. Cl. CPC H04L 41/147; H04L 41/16

(57) ABSTRACT

The invention relates to an automatic deployment system and a method thereof. The automatic deployment system includes an input unit, a simulation unit, and a deployment unit. The input unit receives a first actual transmission information of a user device in the absence of signal path redistributors. The simulation unit receives a simulation parameter and generates a first simulation information and a second simulation information based on the simulation parameter. The deployment unit trains and generates a prediction deployment model using the first actual transmission information, the first simulation information, and the second simulation information. The prediction deployment model generates a prediction deployment information based on the second actual transmission information. The method for automatic deployment involves steps related to utilizing an automatic deployment signal path redistribution system to generate the prediction deployment information.

### BACKGROUND OF THE INVENTION

This application claims priority for the TW application No. 113142381 filed on 5 Nov. 2024, the content of which is incorporated by reference in its entirely.

### FIELD OF THE INVENTION

The invention relates to a deployment system for signal path redistributors and a method thereof, in particular, to a system and method for automatically generating prediction deployment information for deploying signal path redistributors through transmission performance information between user devices and base stations before the actual deployment of signal path redistributors.

### DESCRIPTION OF THE PRIOR ART

In the fifth generation of wireless communication technology, millimeter waves are widely used to achieve high-speed data transmission. However, due to the high-frequency characteristics of millimeter waves, they face serious obstruction and non-line-of-sight (NLoS) transmission problems during transmission, which limits the coverage and effectiveness of millimeter wave technology.

In order to solve the problems, researchers have proposed a signal path redistributor (SPR) based on metamaterials. The technology can effectively reflect and redirect high-frequency signals (millimeter wave, sub THz, terahertz (THz), visible light) to the desired transmission direction. Since the signal path redistributor does not consume power, it is considered a potential solution to improve signal coverage and enhance throughput performance.

However, the deployment process of the signal path redistributor presents certain technical challenges. First, to ensure the effectiveness of the signal path redistributor, precise measurements must be taken to determine the optimal mounting position and reflection angle. Second, these tuning processes are often time-consuming and require trial and error, which increases deployment complexity and cost. As the requirements in signals change in dynamic environments, the static configuration of signal path redistributors can hardly meet the needs of real-time adjustment, resulting in insufficient coverage or reduced signal performance.

Therefore, there is still a problem in the prior art on how to dynamically and efficiently configure and deploy signal path redistributors. In particular, the problem includes how to achieve rapid and accurate deployment of signal path redistributors to cope with signal blocking and non-line-of-sight transmission challenges in different environments, and how to maximize signal coverage and throughput while reducing the time required for laborious measurement and adjustment of signal path redistributors during deployment. In addition, how to make the signal path redistributor adaptive to dynamic environmental changes to maintain stable signal performance is also a technical problem that needs to be solved urgently.

### SUMMARY OF THE INVENTION

In view of the problems in the prior art, through dynamic and adaptive configuration in dynamic environments, the signal path redistributors may be deployed quickly and effectively to better meet the needs of modern high-speed wireless communications.

According to the objective of the invention, an automatic deployment system is provided, which includes an input unit, a simulation unit, and a deployment unit. The input unit receives a first actual transmission information in the absence of signal path redistributors. The simulation unit receives a simulation parameter and simulates to generate a first simulation information and a second simulation information according to the simulation parameter. The deployment unit is connected to the simulation unit and the input unit. The deployment unit trains and generates a prediction deployment model according to the first actual transmission information, the first simulation information, and the second simulation information, using the prediction deployment model to generate a prediction deployment information according to the second actual transmission information.

According to the objective of the invention, an automatic deployment method is provided, which is applied to the automatic deployment signal path redistributor system. The automatic deployment signal path redistributor system includes an input unit, a simulation unit, and a deployment unit. The automatic deployment method includes steps of: receiving, by the input unit, a first actual transmission information in the absence of signal path redistributors; receiving, by the simulation unit, a simulation parameter and simulating to generate a first simulation information and a second simulation information according to the simulation parameter; training and generating, by the deployment unit, a prediction deployment model according to the first actual transmission information, the first simulation information, and the second simulation information, and using the prediction deployment model to generate a prediction deployment information according to the first actual transmission information.

According to the above descriptions, the automatic deployment system and method thereof of the invention may automatically complete the deployment of signal path redistributors in a dynamic environment, reducing the manpower and time costs in the traditional manual adjustment process, making the deployment process in a modern high-speed wireless communication environment more flexible and rapid. The deployment unit in the invention has an adaptive function, may generate the prediction deployment model according to actual transmission data and simulation parameters, and dynamically adjust the deployment parameters according to the performance threshold to ensure the best deployment result. This allows the signal path redistributor to cope with changing communication environments, and to react quickly and adjust regardless of signal blockages or other external factors.

### BRIEF DESCRIPTION OF THE DRAWINGS

FIG. 1 is a block diagram of the architecture of the invention applied in a communication environment.

FIG. 2 is a schematic diagram of signal transmission and interference when the invention is applied in the communication environment.

FIG. 3 is a schematic diagram of a prediction deployment model according to the invention.

FIG. 4 is a schematic diagram of a first encoder of a first artificial intelligence model according to the invention.

FIG. 5 is a schematic diagram of a first decoder of the first artificial intelligence model according to the invention.

FIG. 6 is a schematic diagram of a second decoder of a second artificial intelligence model according to the invention.

FIG. 7 is a schematic diagram of a second decoder of a second artificial intelligence model according to the invention.

FIG. 8 is a flow chart of automatically deploying a signal path redistributor according to the invention.

FIG. 9 is a flow chart of generating a first simulation information and a second simulation information according to the invention.

FIG. 10a is a partial chart of offline training of the prediction deployment model according to the invention.

FIG. 10b is another part of flow chart of offline training and online execution of the prediction deployment model according to the invention.

### DESCRIPTION OF THE PREFERRED EMBODIMENTS

Embodiments of the invention will be further explained with the help of the related drawings below. Wherever possible, in the drawings and the description, the same reference numbers refer to the same or similar components. In the drawings, shapes and thicknesses may be exaggerated for simplicity and convenience. It should be understood that the elements not particularly shown in the drawings or described in the specification have forms known to those skilled in the art. Those skilled in the art can make various changes and modifications based on the content of the invention.

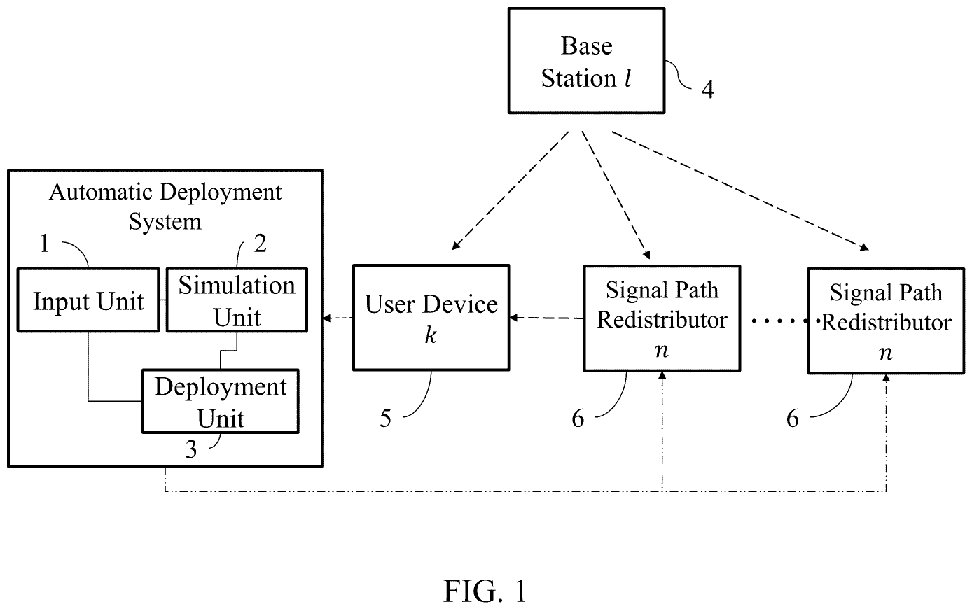

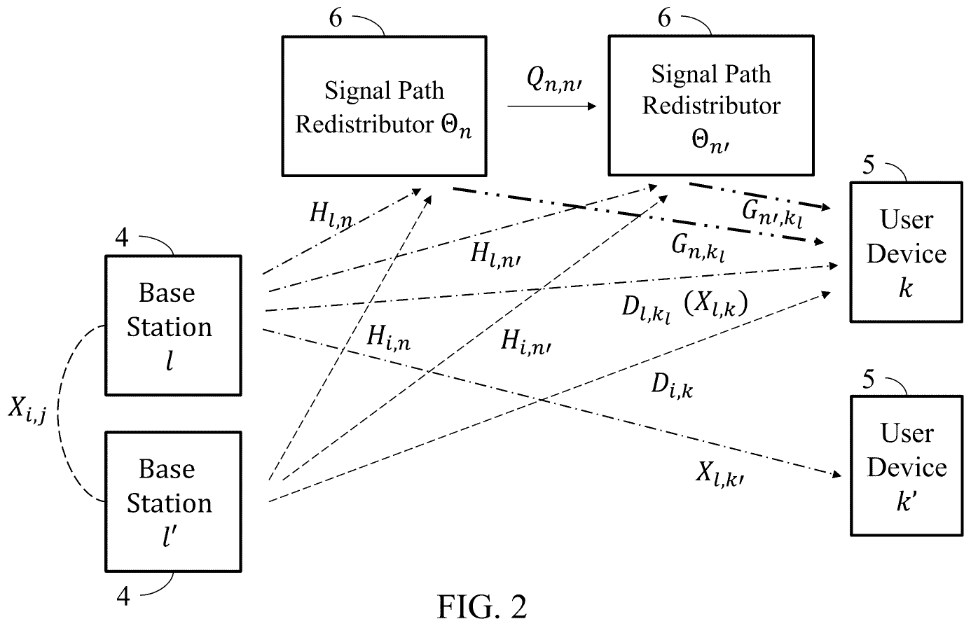

As shown in FIGS. 1 and 2, the invention is an automatic deployment system for a signal path redistributor 6, which includes an input unit 1, a simulation unit 2 and a deployment unit 3. The automatic deployment system is applied to a communication environment. In addition to the automatic deployment system, the communication environment also includes at least one base station 4, at least one user device 5 and at least one signal path redistributor 6. The input unit 1 receives a first actual transmission information xᵢₙ in the absence of signal path redistributors 6. The simulation unit 2 receives a simulation parameter and simulates to generate a first simulation information o₁ and a second simulation information o₂ according to the simulation parameter. The deployment unit 3 is connected to the simulation unit 2 and the input unit 1. The deployment unit 3 trains and generates a prediction deployment model according to the first actual transmission information xᵢₙ, the first simulation information o₁, and the second simulation information o₂, using the prediction deployment model to generate a prediction deployment information ô₂ according to the second actual transmission information.

In some embodiments of the invention, in the communication environment, positions, orientations (horizontal angle and pitch angle) and heights of each base station 4, each user device 5 and each signal path redistributor 6 are defined by Cartesian coordinates, as shown in Formulas (1)-(3):

$${X}_{n}^{SPR} ( {x}_{n}^{SPR} , {y}_{n}^{SPR} , {h}_{n}^{SPR} , {ϑ}_{n}^{SPR} , {φ}_{n}^{SPR} ) \qquad Formula ( 1 )$$

$${X}_{k}^{UE} ( {x}_{k}^{UE} , {y}_{k}^{UE} , {h}_{k}^{UE} , {ϑ}_{k}^{UE} , {φ}_{k}^{UE} ) \qquad Formula ( 2 )$$

$${X}_{l}^{BS} ( {x}_{l}^{BS} , {y}_{l}^{BS} , {h}_{l}^{BS} , {ϑ}_{l}^{BS} , {φ}_{l}^{BS} ) \qquad Formula ( 3 )$$

wherein n, k, l is a positive integer. SPRᵣₑₚᵣₑₛₑₙₜₛ the signal path redistributor 6, UE represents the user device 5, and BS represents the base station 4;

$${X}_{n}^{SPR}$$

is the nth signal path redistributor 6,

$${x}_{n}^{SPR}$$

is the coordinate value in the x axial direction of the nth signal path redistributor 6,

$${y}_{n}^{SPR}$$

is the coordinate value in the y axial direction of the nth signal path redistributor 6,

$${h}_{n}^{SPR}$$

is the coordinate value in the z axial direction of the nth signal path redistributor 6,

$${ϑ}_{n}^{SPR}$$

is the horizontal angle of the nth signal path redistributor 6, and

$${φ}_{n}^{SPR}$$

is the pitch angle of the nth signal path redistributor 6;

$${X}_{k}^{UE}$$

is the kth user device 5,

$${x}_{k}^{UE}$$

is the coordinate value of kth user device 5 in the x axial direction,

$${y}_{k}^{UE}$$

is the coordinate value of k the user device 5 in the y axial direction,

$${h}_{k}^{UE}$$

is the coordinate value of kth user device 5 in the z axial direction,

$${ϑ}_{k}^{UE}$$

is the horizontal angle of the kth user device 5, and

$${φ}_{k}^{UE}$$

is the pitch angle of the kth user device 5;

$${X}_{l}^{BS}$$

is the lth base station 4,

$${x}_{l}^{BS}$$

is the coordinate value of lth base station 4 in the x axial direction,

$${y}_{l}^{BS}$$

is the coordinate value of lth base station 4 in the y axial direction,

$${h}_{l}^{BS}$$

is the coordinate value of lth base station 4 in the z axial direction,

$${ϑ}_{l}^{BS}$$

is the horizontal angle of the lth base station 4, and

$${φ}_{l}^{BS}$$

is the pitch angle of the lth base station 4; in addition, the following references to the base station 4, the user device 5 and the signal path redistributor 6 do not limit the number.

In some embodiments of the invention, the phase shift matrix of the signal path redistributor 6 may be expressed by the following formula (4):

$${Θ}_{n} = [ \begin{matrix}{β}_{n , 1} {e}^{j {ϕ}_{n , 1}} & 0 & … & 0 \\ 0 & {β}_{n , 2} {e}^{j {ϕ}_{n , 2}} & & ⋮ \\ ⋮ & & ⋱ & 0 \\ 0 & … & 0 & {β}_{n , M} {e}^{j {ϕ}_{n , M}}\end{matrix} ] \qquad Formula ( 4 )$$

wherein Θₙ represents the phase shift matrix of the nth signal path redistributor, M represents the Mth reflection of the nth signal path redistributor, 0≤β_{n,M}≤1 is the amplitude constraint of the Mth reflection unit of the nth signal path redistributor 6, and 0≤φ_{n,M}≤2π is the phase constraint of the Mth reflection unit of the nth signal path redistributor 6.

As shown in FIG. 2, the first indirection channel between the lth base station 4 and the n th signal path redistributor 6 is expressed by H_{l,n}, the second indirection channel between the nth signal path redistributor 6 and the kth user device 5 is expressed by G_{n,k}, the direct channel between the lth base station 4 and the kth user device 5 is expressed by D_{l,k}, and the mutual channel between the nth signal path redistributor 6 and the n′th signal path redistributor 6 is expressed by Q_{n,n′}. The base station 4, the signal path redistributor 6, and the user device 5 of the first indirect channel H_{l,n}, the second indirect channel G_{n,k}, the direct channel D_{l,k}, or the mutual channel Q_{n,n′} may play the role of a transmitter or a receiver. The geometric relationship parameters between the transmitters or receivers of the above-mentioned various channels are highly correlated.

In some embodiments of the invention, the above channels are established using a general channel model in the frequency range of 0.5-100 GHz in the 3GPP 38.901 specification document of the fifth generation communication system (see ETSI TR 138 901 V18.0.0 (2024-05)), and the general channel model follows the following formula (5):

$$H = {P}_{LoS} {H}_{LoS} + {P}_{NLoS} {H}_{NLoS} \qquad Formula ( 5 )$$

wherein H is the general formula of the channel, P_{LoS} represents the line of sign (LoS), and P_{NLoS} represents the probability of non-line of sight (NLoS) path. The above is based on the distance and environmental parameters specified in the 3GPP 38.901 specified file. The general channel H may be applied to the aforementioned first indirect channel H_{l,n,}, the second indirect channel G_{n,k}, the direct channel D_{l,k} or the mutual channel Q_{n,n′}.

Further, LoS channel is expressed by H_{LoS}, NLoS channel is expressed by H_{NLoS}, the LoS channel and the NLoS of the nodes a and b are expressed by Formula (6) and Formula (7) respectively, wherein the nodes a and b refer to that one of any two of the base station 4, the user device 5 and the signal path redistributor 6 is the node a, and the other is the node b:

$${H}_{LoS}^{a - b} = \sqrt{A ( {ϑ}^{a - b} , {φ}^{a - b} ) \cdot {PL}^{a - b} {L}_{mat}^{a - b}} \cdot a ( {ϑ}^{x} , {φ}^{x} ) {a}^{T} ( {ϑ}^{y} , {φ}^{y} ) \qquad Formula ( 6 )$$

$${H}_{NLoS}^{a - b} = {\sum }_{c = 1}^{C} {\sum }_{s = 1}^{{S}_{c}} {ε}_{c , s} \sqrt{A ( {ϑ}_{c , s}^{a - b} , {φ}_{c , s}^{a - b} ) \cdot {PL}_{c , s}^{a - b} {L}_{c , s , mat}^{a - b}} \cdot a ( {ϑ}_{c , s}^{x} , {φ}_{c , s}^{x} ) {a}^{T} ( {ϑ}_{c , s}^{y} , {φ}_{c , s}^{y} ) \qquad Formula ( 7 )$$

### Formula (7)

wherein PL^{a-b} is the transmission loss and penetration loss, depending on the transmission distance and application scenario defined in the 3GPP 38.901 specification file;

$${L}_{mat}^{a - b}$$

depends on the loss of the material of object materials; A(ϑ^{a-b},φ^{1-b}) is a predetermined antenna chart; a(ϑ^{x},φ^{x}) represents the array response vector, and a^{T}(ϑ^{y},φ^{y}) is the transpose of the array response vector; the superscript {x,y} depends on the node of the departure and the node of the arrival place. For example, in the first indirect channel H_{l,n} from the base station 4 to the signal path redistributor 6, if a=BS(Base Station), b=SPR(Signal Path Redistributor), then x=BS−SPR, y=BS. In the second indirect channel G_{n,k} from the signal path redistributor 6 to the user device 5, if the node a=BS, b=UE(User Device), then x=UE, y=SPR−UE; in the mutual channel Q_{n,n′} between two signal path redistributors, if a=SPR, b=SPR, then x=y=SPR; in the above, BS represents the base station 4, UE represents the user device 5, and SPR represents the signal path redistributor 6. In addition, the NLoS path has C NLoS clusters, and each cluster has S_{c} scattered bodies at

$$( {H}_{NLoS}^{a - b} ) .$$

The gains of NLoS complex paths in the cluster (c) and dispersion (s) of each NLoS cluster are normalized and defined as ε_{c,s}.

As shown in FIG. 2, the kth user device 5 through the Θₙth signal path redistributor 6 and the Θ_{n′}th signal path redistributor 6 to receive the expectation signal X_{l,k} from the lth base station 4, and the interference signal X_{l,k′} from the lth user device and other user devices 5. The receiving signal model of the kth user device 5 may be expressed by the following formula (8):

$${Y}_{l , k} = {H}_{l , k}^{eff} ( {X}_{l , k} + {\sum }_{{k}^{′} \neq k , k ∈ {K}_{l}}^{{K}_{l}} {X}_{l , {k}^{′}} ) + {\sum }_{i \neq l}^{L} {H}_{i , k}^{eff} {\sum }_{j ∈ {K}_{{i}^{′}}}^{{K}_{i}} {X}_{i , j} + {N}_{k} \qquad Formula ( 8 )$$

wherein Y_{l,k} represents the receiving signal transmitted by the lth base station 4 to the k th user device 5, and Nₖ represents the noise of the kth user device 5; the expectation signal X_{l,k} sent by the lth base station 4 to the kth user device 5, and X_{l,k′} is the interference signal the lth base station 4 and other user devices 5;

$${\sum }_{i \neq l}^{L} {H}_{i , k}^{eff} {\sum }_{j ∈ {K}_{{i}^{′}}}^{{K}_{i}} {X}_{i , j}$$

represents the interference signal between the lth base station 4 and other base stations 4, the lth base station 4 is expressed by i, and other base station 4 are expressed by j; Kₗ represents the collection of all user devices 5 connected to the lth base station 4, and Kᵢ represents the collection of all user devices 5 of the other base station 4 connected to the ith base station 4.

Further, the effective channel between the lth base station 4 and the kth user device 5 is obtained by the sum of the direct channel D_{l,k} and the second indirect path G_{n,k} of the signal path redistributor 6 with multiple reflections, as shown in the following formula (9):

$${H}_{l , k}^{eff} = {D}_{l , k} + {\sum }_{n = 1}^{N} {G}_{n , k} ( {\prod }_{i = 1}^{n - 1} {Θ}_{{v}_{i}} {Q}_{{v}_{i} , {v}_{i + 1}} ) {Θ}_{{v}_{1}} {H}_{l , {v}_{1}} \qquad Formula ( 9 )$$

wherein

$${H}_{l , k}^{eff}$$

represents the effective channel between the lth base station 4 and the kth user device 5, D_{l,k} represents the channel gain of the direct channel between the lth base station 4 and the kth user device 5,

$${\sum }_{n = 1}^{N}$$

represents the number of the signal path redistributors from the lth base station 4 to kth user device 5 and the channel gain of the second indirect channel between the nth signal path redistributor 6 and the kth user device 5, Θᵥ_{ᵢ} represents the phase shift matrix of the vᵢth signal path redistributor 6, Qᵥ_{_{i′}}ᵥ_{ᵢ}+1 represents the channel gain of the mutual channel between the vᵢth signal path redistributor 6 and the vᵢ₊₁th signal path redistributor 6, and H_{l,v}_{₁} represents the channel gain of the first indirect channel between the lth base station 4 and the vᵢth signal path redistributor 6, and G_{n,k} represents the channel gain of the second indirect channel (from the nth signal path redistributor 6 to the kth user device 5); for example, the effective channel with 1 signal path redistributor 6 is of the form D_{l,k}+G_{n,k}ΘₙH_{l,n}, while a channel with 2 signal path redistributors 6 is of the form D_{l,k}+G_{n,k}ΘₙH_{l,n}+G_{n,k}ΘₙQ_{n′,n}Θ_{n′}H_{l,n′}, and so on; further, vᵢ represents the index of nth reflex positions of the signal path redistributor 6;
for the signal path redistributor 6, based on the above, the reference signal received power (RSRP) between the lth base station 4 and the kth user device 5 may be expressed by the following formula (10):

$${P}_{l , k} = {\vert {H}_{l , k}^{eff} {X}_{l , k} \vert}^{2} \qquad Formula ( 10 )$$

wherein P_{l,k} represents the reference signal received power between the lth base station 4 and the kth user device 5;
in addition, the received signal strength indicator between the lth base station 4 and the k th user device 5 is the function obtained by mapping, which is expressed by the following formula (11):

$${RSSL}_{l . k} = {f}_{RSSI} ( {P}_{l . k} ) \qquad Formula ( 11 )$$

wherein RSSI_{l,k} represents the received signal strength indicator between the lth base station 4 and the kth user device 5;
the signal to interference plus noise ratio (SINR) between the lth base station 4 and the k th user device 5 is expressed by the following formula (12):

$${γ}_{l . k} = \frac{{\vert {H}_{l , k}^{eff} {X}_{l , k} \vert}^{2}}{{I}_{l , k}^{intra} + {I}_{l , k}^{inter} + {σ}^{2}} \qquad Formula ( 12 )$$

wherein γ_{l,k} is the signal to interference plus noise ratio between the lth base station 4 and the kth user device 5,

$${I}_{l , k}^{intra} = {\vert {H}_{l . k}^{eff} {\sum }_{k \neq k , k ∈ {K}_{1}}^{{K}_{l}} {X}_{l , {k}^{′}} \vert}^{2}$$

is the internal interference of the base station 4,

$${I}_{l , k}^{intra} = {\sum }_{i \neq l}^{L} {\vert {H}_{i , k}^{eff} {\sum }_{j ∈ {K}_{t}}^{{K}_{i}} {X}_{i , j} \vert}^{2}$$

is the interference cross the base stations 4, and

$${I}_{l , k}^{intra} + {σ}^{2}$$

represents the noise power.

Therefore, the Shannon capacity between the lth base station 4 and the kth user device 5 is expressed by the following formula (13):

$${R}_{i , k} = {BW}_{l , k} \cdot {log}_{2} ( 1 + {γ}_{l , k} ) \qquad Formula ( 13 )$$

wherein R_{l,k} is the Shannon capacity, and BW_{l,k} is the system operation frequency of the base station 4 and the user device 5 width between the lth base station 4 and the kth user device.

The system total rate between the lth base station 4 and the kth user device 5 is expressed by the following formula (14):

$${R}_{sys} = {\sum }_{i = 1}^{L} {\sum }_{k ∈ {K}_{i}} {R}_{l , k} \qquad Formula ( 14 )$$

wherein R_{sys} is the system total rate between the lth base station 4 and the kth user device 5, and R_{l,k} is the Shannon capacity.

The bit error rate (SINR) between the lth base station 4 and the kth user device 5 is calculated by the function of the signal to interference plus noise ratio, which is expressed by the formula (15):

$${BER}_{l , k} = {f}_{BER} ( {γ}_{l , k} ) = \frac{Number of error bits}{Total transmit bits} \qquad Formula ( 15 )$$

wherein BER_{l,k} is the bit error rate between the lth base station 4 and the kth user device 5, f_{BER}(γ_{l,k}) is the function for calculating the bit error rate, and in other words, the value of the bit error rate depends on the size of the signal to interference plus noise ratio. Generally, the higher the value of the signal to interference plus noise ratio, the lower the bit error rate, because a higher signal to interference plus noise ratio means better signal quality and less interference.

The packet error rate (PER) between the lth base station 4 and the kth user device 5 is calculated by the function of the BER, which is expressed by the formula (15):

$${PER}_{l . k} = {f}_{PER} ( {BER}_{l . k} ) = \frac{Number of erroneous packets}{Total transmit packets} \qquad Formula ( 16 )$$

wherein PER_{l,k} is the packet error rate between the lth base station 4 and the kth user device 5, f_{PER}(BER_{l,k}) is the function for calculating the packet error rate, and in other words, the value of the packet error rate depends on the size of the bit error rate. Generally, when the bit error rate is lower, the packet error rate will also be lower, because a lower bit error rate means that the number of erroneous bits in each packet is reduced, thereby reducing the probability of the entire packet being judged as erroneous.

The packet loss rate (PDR) may be calculated by Formula (17):

$${PDR}_{l , k} = \frac{Number of dropped packets}{Total transmit packets} \qquad Formula ( 17 )$$

Note that in complex communication systems, f_{RSSI}(P_{l,k}), f_{BER}(γ_{l,k}) and f_{PER}(BER_{l,k}) usually do not have a mathematical closed form. The reason is that due to the multiple variables and nonlinear effects in the communication environment f_{RSSI}(P_{l,k}), f_{BER}(γ_{l,k}) and f_{PER}(BER_{l,k}) cannot usually be expressed in a closed mathematical form, but are approximated through simulation, experiment, and data-driven methods.

In reality, it is impossible to use an exhaustive search to obtain the deployment of the signal path redistributor 6 because the dynamic number of measurements of the signal path redistributor 6 will lead to an incredible time cost. Therefore, in the invention, the established simulation unit 2 is relied upon and the concept of domain knowledge transfer is utilized to find the best deployment solution for the scenario where the signal path redistributor 6 exists in the communication environment from the first actual measurement information for the scenario where the signal path redistributor 6 does not exist in the communication environment. In addition, it is practical and time-saving to use the first actual measurement information of the scenario in which the communication environment does not have the signal path redistributor 6 as the input of the invention to perform simulation measurement. The simulation unit 2 may output a first simulation information o₁ in a scenario where the signal path redistributor 6 does not exist in the communication environment, and a second simulation information o₂ in a scenario where the signal path redistributor 6 exists in the communication environment. The first simulation information o₁ includes the number of the base stations 4 and the user devices 5, and their corresponding positions, directions, configurations, and performance indicators, such as RSRP, RSSI, SINR, and throughput. The second simulation information o₂ includes the number of deployed base stations 4, user devices 5 and signal path redistributors 6, and their corresponding positions, directions, configurations and performance indicators, such as RSRP, RSSI, SINR and throughput.

In some embodiments of the invention, the deployment unit 3 is provided with a simulation performance threshold. When the deployment unit 3 generates the prediction deployment information ô₂, the deployment unit 3 compares a performance of the prediction deployment information ô₂ with the simulation performance threshold. When the performance of the prediction deployment information ô₂ meets the simulation performance threshold, the deployment unit 3 will publish the prediction deployment information ô₂ to the signal path redistributor 6 in the communication environment. When the performance of the prediction deployment information does not meet the simulation performance threshold, the plurality of simulation parameters used to generate the prediction deployment model are adjusted to regenerate the prediction deployment information ô₂.

In some embodiments of the invention, the deployment unit 3 is provided with an actual performance threshold; after the deployment unit 3 publishes the prediction deployment information ô₂ to the signal path redistributor 6 in the communication environment, the deployment unit 3 receives a third actual transmission information responded by the user device 5 after the signal path redistributor 6 is deployed, and the deployment unit 3 compares a performance of the third actual transmission information with the actual performance threshold; when the performance of the third actual transmission information meets the actual performance threshold, it means that the deployment is completed; when the performance of the third actual transmission information does not meet the actual performance threshold, it means that the deployment is not completed, then the simulation parameters of the prediction deployment model are adjusted, and then the prediction deployment information ô₂ is regenerated according to the first actual transmission information xᵢₙ.

In some embodiments of the invention, the communication environment includes the base station 4 and the user device 5, and the simulation unit 2 generates a first simulation information o₁ by simulating a state in which only the base station 4 and the user device 5 are present in the communication environment; the first simulation information o₁ includes a first simulation wireless channel and a first simulation transmission performance; the simulation unit 2 simulates each channel for transmitting wireless data between the base station 4 and the user device 5 as the first simulation wireless channel respectively, and the simulation unit 2 simulates the transmission performance in each of the first simulation wireless channels as the first simulation transmission performance respectively.

In some embodiments of the invention, the simulation unit 2 generates a second simulation information o₂ by simulating a state in which the base station 4, the user device 5 and the signal path redistributor 6 are present in the communication environment; the second simulation information o₂ includes a second simulation wireless channel and a second simulation transmission performance; the simulation unit 2 simulates each channel for transmitting wireless data between the base station 4 and the signal path redistributor 6, between the user device 5 and the signal path redistributor 6, and between the signal path redistributor 6 and the other signal path redistributor 6 as the second simulation wireless channel respectively, and the simulation unit 2 simulates the transmission performance in each of the second simulation wireless channels as the second simulation transmission performance respectively.

In some embodiments of the invention, the prediction deployment model of the deployment unit 3 includes a first artificial intelligence model AE1 and a second artificial intelligence model AE2 to form a data-driven network transmission algorithm; the deployment unit 3 receives the first actual transmission information xᵢₙ or the second actual transmission information, and processes the first actual transmission information xᵢₙ, the first simulation information o₁ and the second simulation information o₂ through the training of the first artificial intelligence model AE1 and the second artificial intelligence model AE2 to generate the prediction deployment model. In addition, the second actual transmission information is provided to the prediction deployment model to generate the prediction deployment information ô₂. The first artificial intelligence model AE1 generates a simulation output data ô₁ according to the first actual transmission information xᵢₙ and the first simulation information o₁, and the second artificial intelligence model AE2 generates the prediction deployment information ô₂ according to the simulation output data ô₁ and the second simulation information o₂. The first actual transmission information xᵢₙ is the actual transmission information between the user device 5 and the base station 4; the first artificial intelligence model AE1 generates the simulation output data ô₁ by using the first actual transmission information xᵢₙ and the first simulation information o₁ actually transmitted between the user device 5 and the base station 4, and the second artificial intelligence model AE2 generates the prediction deployment information ô₂ from the simulation output data ô₁ and the second simulation information o₂; the deployment unit 3 transmits the prediction deployment information ô₂ to the signal path redistributor 6 in the environment, so that the signal path redistributor 6 completes the deployment in the actual environment.

In some embodiments of the invention, the first artificial intelligence model AE1 and the second artificial intelligence model AE2 are both autoencoder models (Autoencoder, abbreviated as: AE) in the deep neural network (Deep Neural network, abbreviated as: DNN). Further, the first artificial intelligence model AE1 includes a first encoder ENC1 and a first decoder DEC1, and the first encoder ENC1 and the first decoder DEC1 are both composed of neurons. The first encoder ENC1 receives the first actual transmission information xᵢₙ and the first simulation information o₁, and generates a first latent variable v₁ according to the first actual transmission information xᵢₙ and the first simulation information o₁; the first decoder DEC1 receives the first latent variable v₁ and generates the simulation output data ô₁ according to the first latent variable v₁; in other words, the first encoder ENC1 (real world domain) extracts the features of the first actual transmission information xᵢₙ to form the first latent variable v₁, and generates the simulation output data ô₁ through the first decoder as input to the second artificial intelligence model AE2 (simulation domain). In the invention, the first actual transmission information xᵢₙ of the first artificial intelligence model AE1 is defined as the real measurement data in an environment without the signal path redistributor 6. The actual measurement data may be in the form of multiple receiving reference points, whose metrics include RSRP, RSSI, SINR and throughput; the multiple receiving reference points, whose metrics include RSRP, RSSI, SINR and throughput, may be calculated by the aforementioned formulas (1) to (17). However, the invention is not limited to the above in actual implementation. Further, an input of the first artificial intelligence model AE1 is the measurement data (the first actual transmission information xᵢₙ) and the first simulation information o₁ in the real environment under the scenario of no signal path redistributor 6, and an output thereof is the corresponding simulation data (the simulation output data ô₁) in the simulation environment under the scenario of no signal path redistributor 6. The purpose of this design is to allow the first artificial intelligence model AE1 to map the first actual transmission information xᵢₙ using the first simulation information o₁, so as to perform more accurate simulation and prediction in the subsequent process.

In some embodiments of the invention, the output of the first encoder ENC1 of the first artificial intelligence model AE1 is the first latent variable v₁, and the output of the first decoder DEC1 is the simulation output data ô₁. The first latent variable v₁ and the simulation output data ô₁ are expressed by the following formula (18) and formula (19), respectively:

$${v}_{1} = {f}_{ENC 1} ( {x}_{in} ; {θ}_{ENC 1} ) \qquad Formula ( 18 )$$

$${\hat{o}}_{1} = {f}_{DEC 1} ( {v}_{1} ; {θ}_{DEC 1} ) \qquad Formula ( 19 )$$

wherein θ_{ENC1} and θ_{DEC1} are the model weights of the first encoder ENC1 and the first decoder DEC1 respectively, f_{ENC1}(xᵢₙ;θ_{ENC1}) is the function form of the first actual transmission information represented by the encoding, and f_{DEC1}(v₁;θ_{DEC1}) is the function form of the first latent variable which is the reconstructed output. In the domain transfer of the first artificial intelligence model AE1, the first actual transmission information xᵢₙ has the same dimension as the simulation output data ô₁. Furthermore, the simulation output data ô₁ has the same metric content as the first actual transmission information xᵢₙ. The first latent variable v₁ is a feature representation extracted from the first actual transmission information xᵢₙ of the real world by the first encoder ENC1, which contains the key information or patterns in the first actual transmission information xᵢₙ after the encoding process, which is used to describe the core features of the first actual transmission information xᵢₙ.

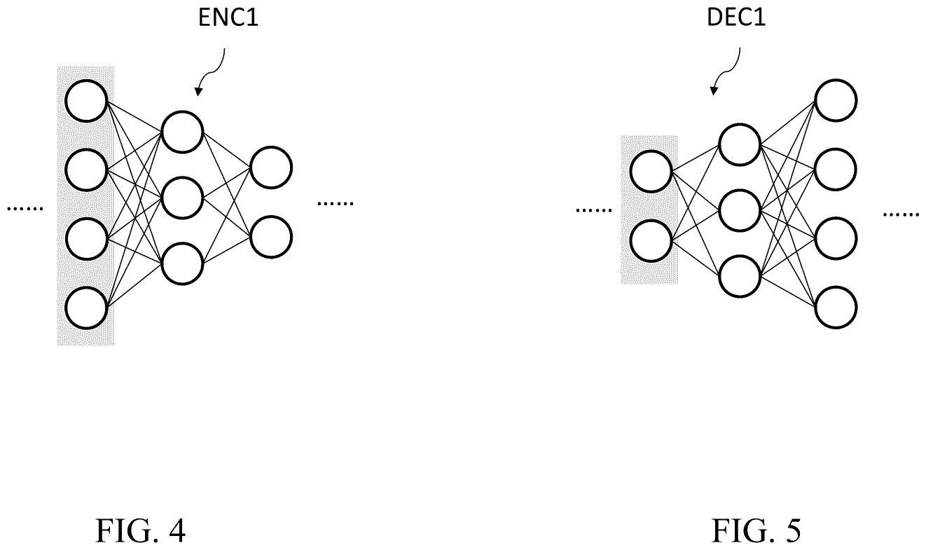

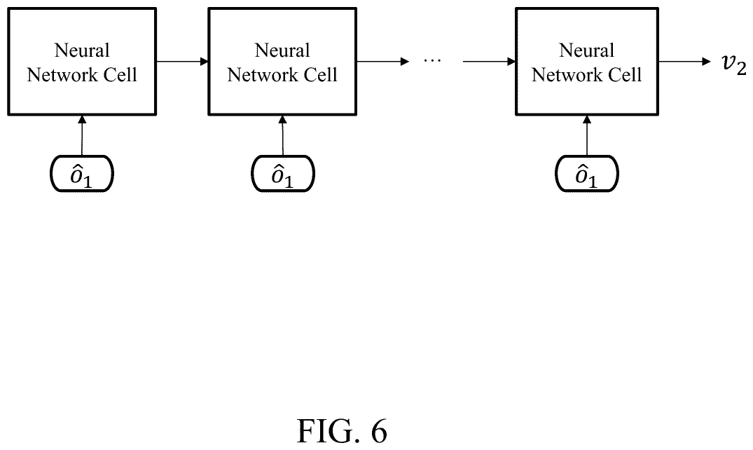

As shown in FIGS. 4 and 5, in the invention, the first encoder ENC1 and the first decoder DEC1 are composed of multiple layers of neurons. Moreover, in the first encoder ENC1, the higher layers have fewer neurons, the lower layers have more neurons; in the first decoder DEC1, the lower layers have fewer neurons, the higher layers have more neurons. Furthermore, the number of neurons in the last layer of the first encoder ENC1 is the same as the number of neurons in the first layer of the first decoder DEC1, and the number of neurons in the first layer of the first encoder ENC1 is the same as the number of neurons in the last layer of the first decoder DEC1. Also, each neuron represents a weight, and all neurons constitute the entire model weight θ. The relationship between the layers of the neural network is as shown in formula (20):

$${y}_{t + 1} = {f}_{act} ( {W}_{t} {x}_{t} + {b}_{t} ) \qquad ( 20 )$$

wherein yₜ₊₁ represents the output of t+1 layers, xₜ represents the input of tth layer, Wₜ is the model weight of tth layer, bₜ is the bias weight of tth layer; f_{act} may be any type of nonlinear activation function, such as hyperbolic tangent (tanh(·)), ReLU (rectified linear unit), and leaky ReLU, etc., and t is a positive integer.

The first loss function design of the first artificial intelligence model AE1 of the invention may be formula (21):

$${L}_{1} = {\sum }_{i} {( {\hat{o}}_{1 , i} - {o}_{1 , i} )}^{2} \qquad Formula ( 21 )$$

wherein i represents the index of nth output, L₁ represents the first loss function (the first loss function is the minimum mean square error loss function), and ô_{1,i} represents the difference between the simulation output data and the first simulation information.

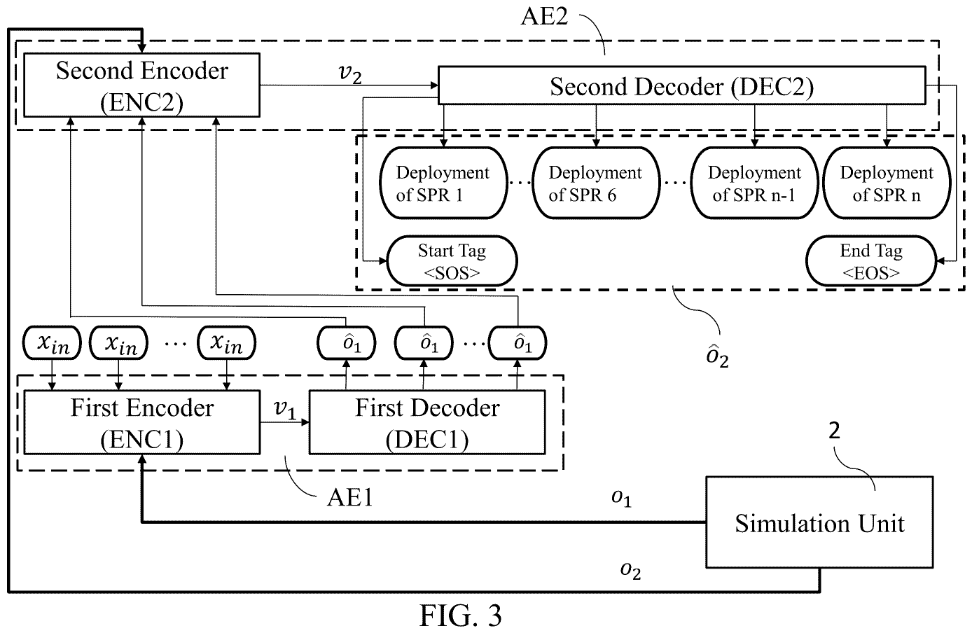

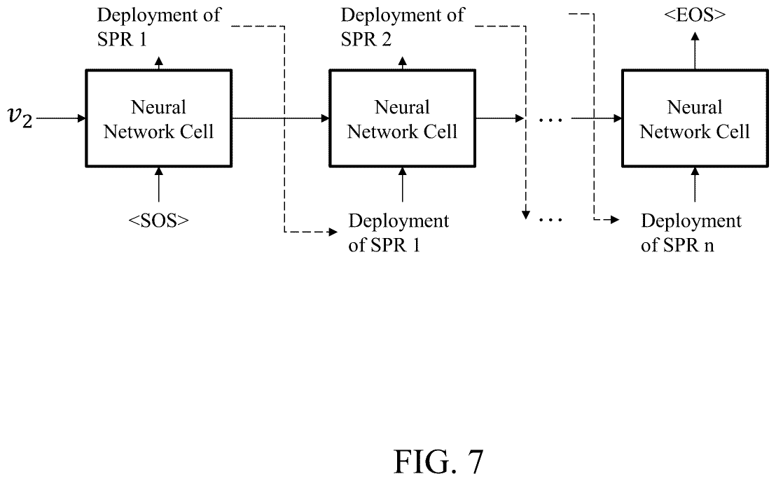

As shown in FIG. 3, the second artificial intelligence model AE2 is used to predict the precise number of the signal path redistributors 6 deployed in the communication environment to improve or achieve the required performance requirements; therefore, the second artificial intelligence model AE2 generates the prediction deployment information ô₂, including the number of the signal path redistributors 6 and their corresponding positions, directions and configurations, as well as performance indicators such as RSRP, RSSI, SINR and throughput. In addition, the second artificial intelligence model AE2 is different from the first artificial intelligence model AE1 in that since the number of the signal path redistributors 6 in the communication environment needs to be dynamically deployed to meet the actual usage requirements; therefore, the second artificial intelligence model AE2 may be designed as a sequence-to-sequence (seq2seq) mode to be suitable for dynamically outputting the prediction deployment information ô₂; in other words, the second artificial intelligence model AE2 may sequentially generate the prediction deployment data of the 1st to N signal path redistributors 6 in the communication environment to form the prediction deployment information ô₂ of the 1st to N signal path redistributors 6 in the communication environment. As shown in FIGS. 3, 6 and 7, the second artificial intelligence model AE2 includes a second encoder ENC2 and a second decoder DEC2; the data sequence of the second simulation information o₂ input into the second encoder ENC2 is the same as the data sequence of the simulation output data ô₁ output by the first artificial intelligence model AE1, the second encoder ENC2 and the second decoder DEC2 have the same number of sequence units, and each of the sequence units is a neural network layer. The output of the second encoder ENC2 is a second latent variable v₂, and is expressed as the following formula (22):

$${v}_{2} = {f}_{ENC 2} ( {\hat{o}}_{1} ; {o}_{ENC 2} ) \qquad Formula ( 22 )$$

wherein f_{ENC2} is the mapping function, the input of f_{ENC2} is the simulation output data ô₁, θ_{ENC2} is the model weight of the second encoder ENC2, and the second latent variable v₂ is the input of the second decoder DEC2; it should be noted that the purpose of inputting the second simulation information o₂ into the second encoder ENC2 is to allow the second artificial intelligence model AE2 to map the simulation output data ô₁ using the second simulation information o₂, so as to perform more accurate simulation and prediction in the subsequent process.

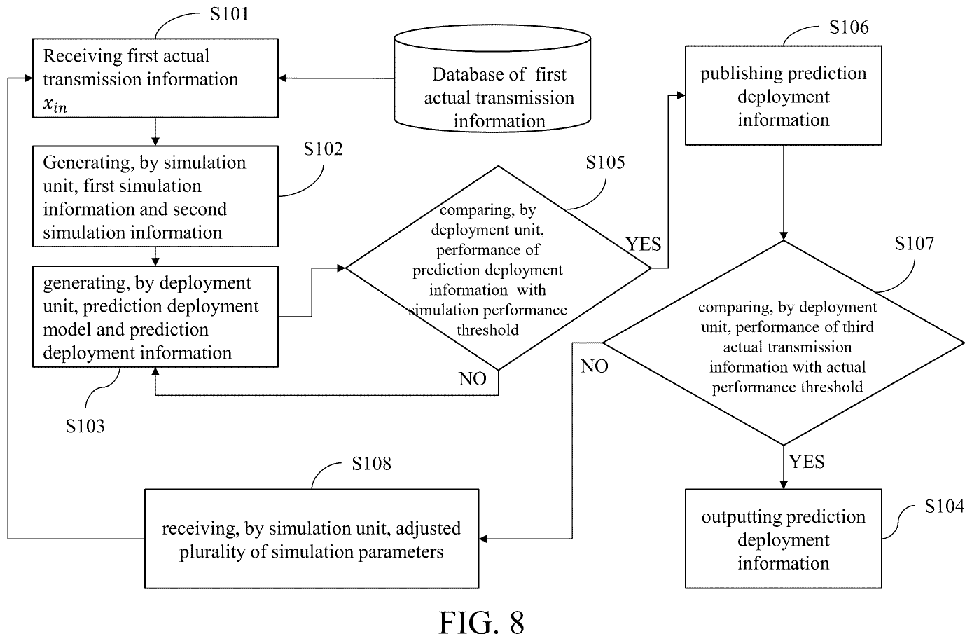

As shown in FIGS. 3 and 7, the architecture of the second decoder DEC2 is different from that of the second encoder ENC2. The second decoder DEC2 further includes two start tags<SOS> and end tags<EOS>, indicating the start of a sequence and the end of a sequence respectively. The prediction deployment data will be embedded between the start tag <SOS> and the end tag <EOS> in the form of {<SOS>, <Data1>, <Data2>, . . . <Data N>, <EOS>}. By controlling the start tag <SOS> and the end tag <EOS> in the prediction deployment data, the prediction deployment information ô₂ of the signal path redistributor 6 may be obtained dynamically. The prediction deployment information ô₂ may be expressed as {<SOS>, <Deployment of SPR 1>, <Deployment of SPR 2>, . . . <Deployment of SPR N>, <System Performance 1>, <System Performance 2>, . . . <System Performance N>, <EOS>}, where N may be a dynamic number and a positive integer. In actual implementation of the invention, the start tag <SOS> and the end tag <EOS> may further be expressed by other characters, such as letters, number systems or punctuation marks.

It should further be noted that the <Deployment of SPR 1>, <Deployment of SPR 2>, . . . <Deployment of SPR N> in the prediction deployment information ô₂ may include a plurality of detailed information, including the corresponding position

$$( {x}_{n}^{SPR} , {y}_{n}^{SPR} , {h}_{n}^{SPR} )$$

and direction

$$( {ϑ}_{n}^{SPR} , {φ}_{n}^{SPR} )$$

of the signal path redistributor 6 and the phase shift matrix Θₙ of the signal path redistributor 6. The architecture of the second decoder DEC2 is more complex than that of the second encoder ENC2. The output of the ith sequence in the sequence of the second decoder DEC2 may be obtained through the previous layer (i.e., (1−1)th layer) of the ith sequence, which may be expressed by the following formula (23):

$${seq}_{i} = {f}_{DEC 2 , i} ( {seq}_{i - 1} ; {θ}_{DEC 2 , i} ) \qquad Formula ( 23 )$$

wherein θ_{DEC2,i} is the model weight of the ith sequence, f_{DEC2,i} represents the function of the ith neural network unit layer of the second decoder DEC2, seqᵢ represents the output of the ith sequence, and i is a positive integer.

Further, the input of the first sequence θ_{DEC2,1} of the second decoder DEC2 is the second latent variable v₂, seq₀ is the start tag <SOS>, and the output of the final sequence is seq_{last_cell} (the end tag <EOS>). Every next sequence of the second decoder DEC2 will be trained until the EOS tag appears. By removing the start tag and the end tag, assuming that the sequence length of the second decoder DEC2 is V, and V is a positive integer, the prediction deployment information ô₂ of the second decoder DEC2 may be expressed as formula (24):

$${\hat{o}}_{2} = [ {seq}_{v} , … , {seq}_{v - 1} , … {seq}_{2} , {seq}_{1} ] \qquad Formula ( 24 )$$

wherein v represents the index of the sequence and is a positive integer from 1 to V.

In some embodiments of the invention, the first artificial intelligence model AE1 and the second artificial intelligence model AE2 may be deep neural networks (DNNs) or other alternatives, such as recurrent neural networks, long-short-term memory, and Transformer-based architectures, depending on the properties of the input sequence.

Since the second artificial intelligence model AE2 generates prediction deployment information ô₂, we apply the second loss function L₂ to the third actual transmission information and the prediction deployment information ô₂ in each sequence unit to measure the error between the third actual transmission information and the prediction deployment information ô₂, the second loss function L₂ may be a cross entropy loss function. \, and the second loss function is expressed by the following formula (25) under the condition that the sequence length of the second decoder is V:

$${L}_{2} = - {\sum }_{v = 1}^{V} {p}_{DEC 2 , v} log ( {\hat{p}}_{DEC 2 , v} ) \qquad ( 25 )$$

wherein p_{DEC2,v} and \hat{p}_{DEC2,v} are the third actual transmission information and the prediction deployment information ô₂ of the vth deployment. Further, the third actual transmission information (p_{DEC2,v}) is collected through exhaustive search.

In some embodiments of the invention, the first artificial intelligence model AE1 and the second artificial intelligence model AE2 may perform back propagation to update the neural network weights θ, as shown in the following general formula (26):

$$θ ← θ - η \cdot {∇}_{θ} L \qquad Formula ( 26 )$$

When the first artificial intelligence model AE1 performs back propagation, L is the first loss function L₁, and performing, by the first artificial intelligence model AE1, back propagation to update the neural network weights θ₁ may be rewritten as:

$${θ}_{1} ← {θ}_{1} - η \cdot {∇}_{θ} {L}_{1}$$

wherein the first neural network weights θ₁ of the first encoder ENC1 and the first decoder DEC1 of the first artificial intelligence model AE1 include a first weight parameter W₁ and a first bias parameter b₁, and the first weight parameter W₁ and the first bias parameter b₁ are optimized during the training process to minimize the first loss function L₁. η: The learning rate is a hyperparameter that determines the step size for updating the first weight parameter W₁ and the first bias parameter b₁ of the first artificial intelligence model AE1 each time, and controls the distance that the first artificial intelligence model AE1 should move each time the gradient descent occurs. ∇_{θ}L₁: The gradient of the first loss function L₁ with respect to the first neural network weight of the first artificial intelligence model indicates the direction and rate of change of the first loss function L₁ when the first weight parameter W₁ and the first bias parameter b₁ change.

When the second artificial intelligence model AE2 performs back propagation, L is the second loss function L₂, and performing, by the second artificial intelligence model AE2, back propagation to update the neural network weights θ₂ may be rewritten as:

$${θ}_{2} ← {θ}_{2} - η \cdot {∇}_{θ} {L}_{2}$$

wherein the second neural network weights θ₂ of the second artificial intelligence model AE2 include second weight parameters W₂ and second bias parameters b₂ of the second encoder ENC2 and the second decoder DEC2. The second weight parameter W₂ and the second bias parameter b₂ are optimized during the training process to minimize the second loss function L₂. η: The learning rate is a hyperparameter that determines the step size for updating the second weight parameter W₂ and the second bias parameter b₂ of the second artificial intelligence model AE2 each time, and controls the distance that the second artificial intelligence model AE2 should move each time the gradient descent occurs. ∇_{θ}L₂: The gradient of the second loss function L₂ with respect to the second neural network weight θ₂ of the second artificial intelligence model AE2 indicates the direction and rate of change of the second loss function L₂ when the second weight parameter W₂ and the second bias parameter b₂ change.

In the invention, the second artificial intelligence model AE2 input the simulation output data ô₁ provides prediction data when no signal path redistributor 6 is deployed, and the second simulation information o₂ provides data when the signal path redistributor 6 is deployed. The purpose of the second artificial intelligence model is to achieve performance prediction from data in the scenario without the signal path redistributor 6 to the deployment of the signal path redistributor 6 by learning the relationship between the two, and further optimize the deployment decision. The simulation output data ô₁ and the second simulation information o₂ provide predictions for the simulation to enter the real deployment, helping the second artificial intelligence model AE2 to better understand the differences between the real environment and the simulation environment, thereby making more reliable predictions.

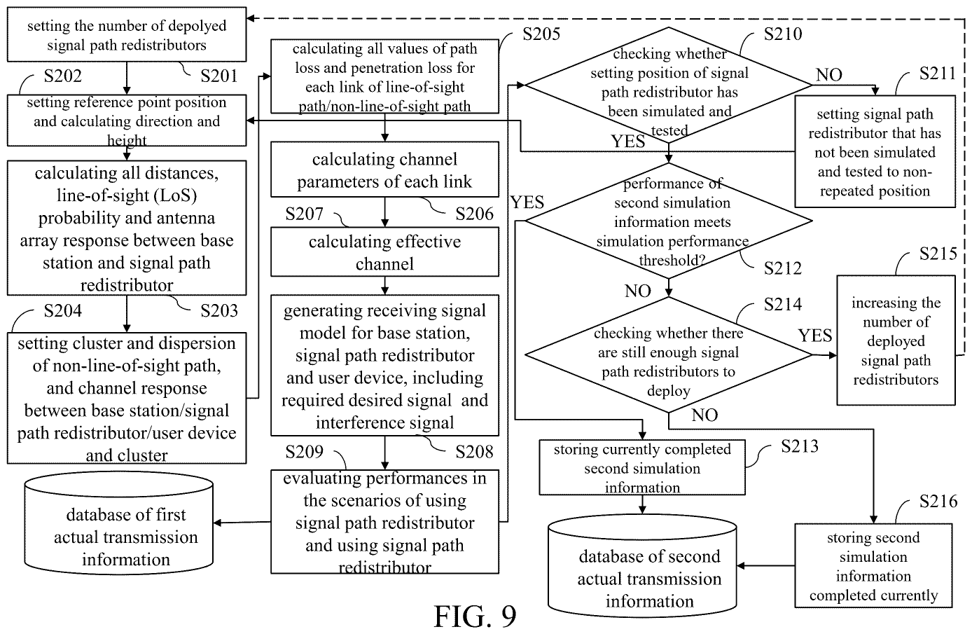

As shown in FIG. 8, the invention is an automatic deployment method for the signal path redistributor 6, which is applied to the automatic deployment system; the automatic deployment system includes an input unit 1, a simulation unit 2 and a deployment unit 3. The automatic deployment method for the signal path redistributor 6 includes the following steps.
(S101) The input unit 1 receives a first actual transmission information xᵢₙ in the absence of the signal path redistributor 6 from a database that stores the first actual transmission information xᵢₙ in advance;
(S102) the simulation unit 2 receives a plurality of simulation parameters, and simulates to generate a first simulation information and a second simulation information according to the plurality of simulation parameters;
(S103) the deployment unit 3 trains to generate a prediction deployment model according to the first actual transmission information xᵢₙ, the first simulation information and the second simulation information and uses the prediction deployment model to generate a prediction deployment information ô₂ according to the second actual transmission information;
(S104) the prediction deployment information ô₂ is output.

In some embodiments of the invention, the deployment unit 3 is provided with a simulation performance threshold, and after the step of using the prediction deployment model to generate a prediction deployment information ô₂ according to the first actual transmission information xᵢₙ, the method further includes the following steps.
(S105) The deployment unit 3 compares a performance of the prediction deployment information ô₂ with the simulation performance threshold, and when the performance of the prediction deployment information ô₂ does not meet the simulation performance threshold, the step (S103) is performed again;
(S106) the deployment unit 3 publishes the prediction deployment information ô₂ again to the signal path redistributor 6 in the communication environment when the performance of the prediction deployment information ô₂ meets the simulation performance threshold.

In some embodiments of the invention, the deployment unit 3 is provided with an actual performance threshold, and after the deployment unit 3 publishes the prediction deployment information ô₂ to the signal path redistributor 6 in the communication environment, the method further includes the following steps.
(S107) The deployment unit 3 receives a third actual transmission information responded by the signal path redistributor 6 at a deployment position, and the deployment unit 3 compares a performance of the third actual transmission information with the actual performance threshold, wherein when the performance of the third actual transmission information meets the actual performance threshold, indicating that the deployment is completed, the step (S104) is performed;
(S108) when the performance of the third actual transmission information does not meet the actual performance threshold, it means that the deployment is not completed, then the simulation unit 2 receives the adjusted plurality of simulation parameters and then proceeds according to the step (S101).

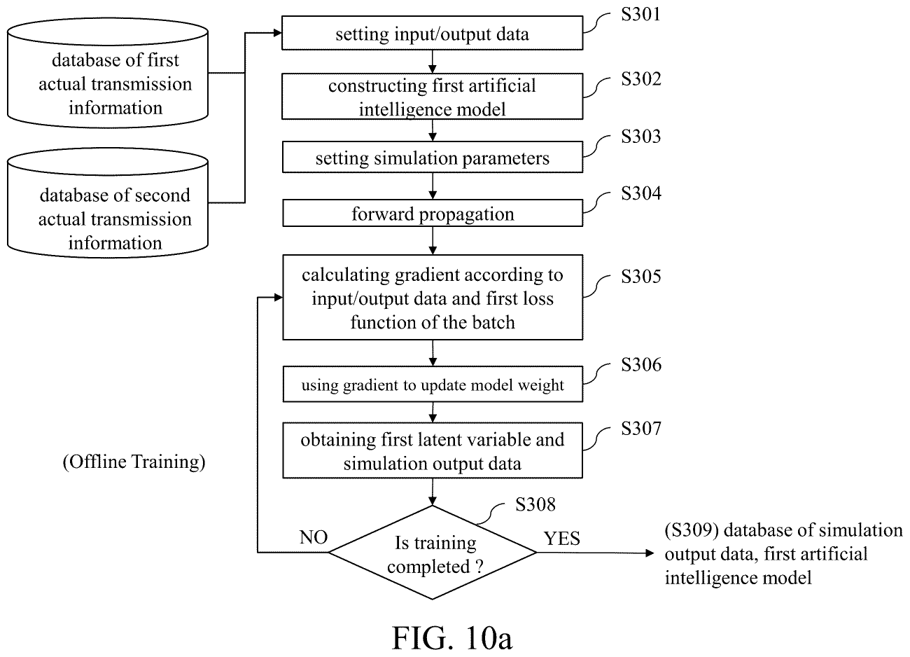

As shown in FIG. 9, in some embodiments of the invention, the step of receiving, by the simulation unit 2, the plurality of simulation parameters to simulate to generate a first simulation information and a second simulation information further includes the following steps.
(S201) The number of the signal path redistributors 6 deployed in the signal path is set, wherein the number of the signal path redistributors 6 deployed in the communication environment does not exceed the number of the signal path redistributors 6 available;
(S202) the reference point positions are set, and the direction and height are calculated: the reference point positions of the base station 4 and the user device 5 in the communication environment without the signal path redistributor 6 are set, and the reference point positions of the base station 4 and the user device 5 in the communication environment with the signal path redistributor 6 are set, wherein regardless of whether there is a signal path redistributor 6 in the communication environment, the reference point positions of the base station 4 and the user device 5 in the communication environment remain unchanged, and the direction (horizontal angle and pitch angle) and the height of the base station 4, the user device 5 and the signal path redistributor 6 are calculated, the dataset format being each reference point positions and corresponding performances, such as throughput, RSSI, SINR, RSRP, BER, PER, PDR;
(S203) all distances, the line-of-sight (LoS) probability and the antenna array response between the base station 4 and the signal path redistributor 6, the signal path redistributor 6 and the user device 5, the base station 4 and the user device 5, the signal path redistributor 6 and the signal path redistributor 6 are calculated according to the set reference point positions and calculated direction and height (such as formula (1), (2), (3));
(S204) a cluster and a dispersion of the non-line-of-sight path are set, and a channel response between the base station 4/the signal path redistributor 6/the user device 5 and the cluster is calculated;
(S205) all values of a path loss and a penetration loss for each link of the line-of-sight path/the non-line-of-sight path are calculated;
(S206) channel parameters of each link (including from the base station 4 to the signal path redistributor 6, from the signal path redistributor 6 to the user device 5, from the base station 4 to the user device 5, and from the signal path redistributor 6 to the signal path redistributor 6) are calculated, as shown in formulas (5), (6), and (7); the channel parameters are the first indirect channel H_{l,n}, the second indirect channel G_{n,k}, the direct channel D_{l,k} or the mutual channel D_{l,k};
(S207) the configuration of the signal path redistributor 6 is generated using formula (4), and an effective channel is calculated using formula (9);
(S208) a receiving signal model is generated for the base station 4, the signal path redistributor 6 and the user device 5, including the required desired signal X_{l,k} and interference signal (such as formula (9));
(S209) the performance in the scenarios of using the signal path redistributor 6 and not using the signal path redistributor 6 is evaluated, and the performance includes one of throughput, RSSI, SINR, RSRP, BER, PER, PDR, etc., or a combination of any two or more thereof, wherein the performance of the signal path redistributor 6 not being deployed is stored as the first simulation information, and the performance evaluation of the remaining scenarios of deploying different numbers of signal path redistributors 6 is completed;
(S210) whether a setting position of the signal path redistributor 6 has been simulated and tested is checked, wherein if the above situation is not completed, the method proceeds to step (S211), otherwise, the method proceeds to step (S212);
(S211) the signal path redistributor 6 that has not been simulated and tested is set to a non-repeated position, and then the method proceeds according to the step (202);
(S212) whether the performance of the second simulation information meets the simulation performance threshold is checked, wherein if the performance does meet the simulation performance threshold, the method proceeds to step (S213), otherwise, the method proceeds to step (S214);
(S213) the currently completed second simulation information is stored;
(S214) whether there are still enough signal path redistributors 6 to deploy is checked, i.e., whether the number of currently deployed signal path redistributors 6 is less than the number of signal path redistributors 6 available is checked, wherein if the number of deployed signal path redistributors 6 is less than the set number of deployed signal path redistributors 6, the method proceeds to step (S215), otherwise the method proceeds to the step (S213);
(S215) the number of deployed signal path redistributors 6 is increased and then method proceeds according to the step (201);
(S216) when no additional signal path redistributor 6 is available, the second simulation information with the best performance in the second simulation information collected previously is stored as the second simulation information.

As described above, different numbers of signal path redistributors 6 may be deployed in the communication environment, depending on the layout locations of the signal path redistributors 6 and the communication environment in which they are used.

In some embodiments of the invention, the deployment unit 3 collects the following datasets:
(1) The first actual transmission information xᵢₙ in the case where there is no signal path redistributor 6 in the communication environment, wherein the first actual transmission information xᵢₙ is the communication quality information actually received from the base station 4 or the user device 5;
(2) the first simulation information, and
(3) the second simulation information.

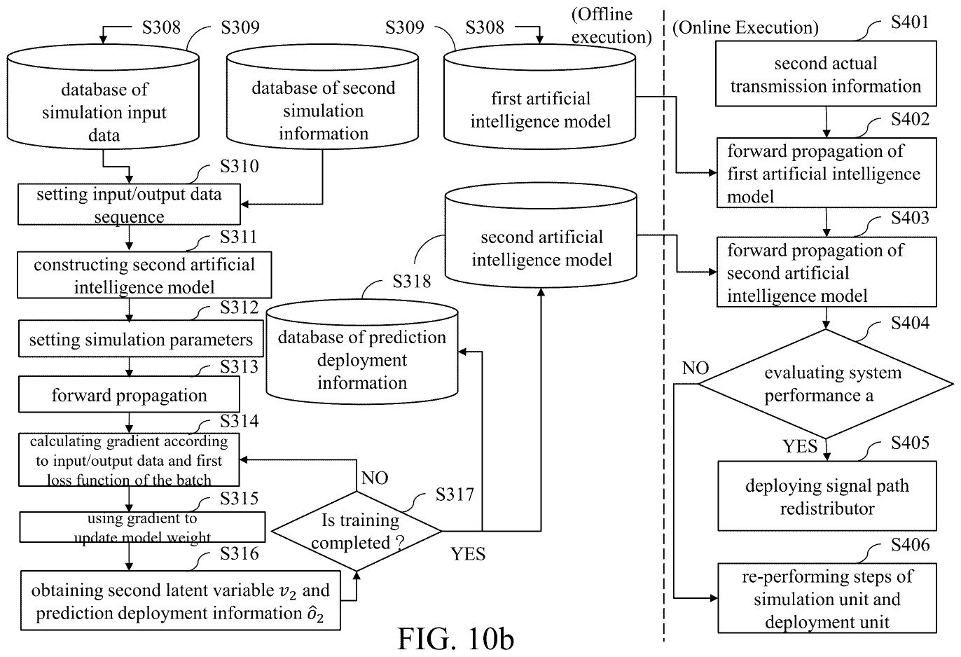

As shown in FIG. 10a and FIG. 10b, in some embodiments of the invention, the deployment unit 3 is divided into two parts of an offline training and an online execution. The deployment unit 3 performs the process of first actual transmission information xᵢₙ to simulating and generating the simulation output data ô₁ in the offline training, which is called domain conversion from the real world (real domain) to the simulation world (simulated domain), and is referred to as steps for domain conversion from real domain to simulation domain (Real2Sim) including:
(S301) the deployment unit 3 uses the first actual transmission information xᵢₙ and the first simulation information to be set as the input data and the output data respectively, which aims at using the first actual transmission information xᵢₙ obtained from the real world before the signal path redistributor 6 is deployed, and the first simulation information obtained previously to train the first artificial intelligence model AE1 in the simulation unit 2, wherein it should be noted that the data dimensions of the first actual transmission information xᵢₙ and the first simulation information are the same;
(S302) corresponding neural network parameters (including the number of neurons and the number of layers) are set to construct the first artificial intelligence model AE1 according to formulas (18), (19) and (20), and the first artificial intelligence model AE1 includes the first encoder ENC1 and the first decoder DEC1.
(S303) the simulation parameters are set for providing to the first artificial intelligence model AE1, wherein the simulation parameters are the same as the plurality of simulation parameters received by the simulation unit 2;
(S304) the forward propagation is performed in the first artificial intelligence model AE1, and the first actual transmission information xᵢₙ and the first simulation information are sent to the first encoder ENC1 and the first decoder DEC1 for forward propagation;
(S305) the gradient of the neural network is calculated according to the first actual transmission information, the first simulation information and the first loss function in formula (21) of the batch;
(S306) the model weights are updated according to the gradient obtained by formula (26);
(S307) the first artificial intelligence model AE1 obtains the first latent variable v₁ and the simulation output data ô₁, the first latent variable v₁ and the simulation output data ô₁, which are formulas (18) and (19);
(S308) whether the training is completed is determined, wherein if the training has not been completed, the method proceeds to the step (S305), and if the training is completed, the method proceeds to the step (S309);
(S309) the simulation output data ô₁ is stored, and the first artificial intelligence model AE1 that completes the training is completed.

In some embodiments of the invention, after the domain conversion step in the offline training, the deployment unit 3 further includes the deployment prediction of the signal path redistributor 6, at which time the second artificial intelligence model AE2 is used to generate the prediction deployment information ô₂, which is called the prediction deployment step;
(S310) the simulation output data ô₁ and the second simulation information ô₂ are used as an input data sequence and an output data sequence respectively;
(S311) corresponding neural network parameters (including the number of neurons and the number of layers) are set to construct the second artificial intelligence model AE2 according to formulas (22), (23) and (24), and the second artificial intelligence model AE2 includes the second encoder ENC2 and the second decoder DEC2;
(S312) the plurality of simulation parameters are set for providing to the second artificial intelligence model AE2, wherein the plurality of simulation parameters are the same as the plurality of simulation parameters received by the simulation unit 2;
(S313) the forward propagation is performed in the second artificial intelligence model AE2, and the simulation output data ô₁ and the second simulation information ô₂ are sent to the second encoder ENC2 and the second decoder DEC2 for forward propagation;
(S314) the gradient of the neural network is calculated according to the third actual transmission information, the prediction deployment information ô₂ and the second loss function in formula (25) of the batch;
(S315) the model weights of the second artificial intelligence model AE2 are updated according to the gradient obtained by formula (26);
(S316) formulas (22) to (24) and the second artificial intelligence model AE2 are used to obtain the second latent variable v₂ and the prediction deployment information ô₂;
(S317) whether the training is completed is determined, wherein if the training has not been completed, the method proceeds to the step (S314), and if the training is completed, the method proceeds to the step (S318);
(S318) the prediction deployment information ô₂ and the second artificial intelligence model AE2 that has been trained are stored.
In some embodiments of the invention, the prediction deployment information ô₂ is stored, including the number of deployments of the signal path redistributors 6, the deployment positions, directions, heights and performance indicators of the corresponding signal path redistributors 6 such as one of RSRP, RSSI, SINR and throughput, or a combination of any two or more.

In some embodiments of the invention, when the deployment unit 3 is at the online execution, the following steps are included:
(S401) the second actual transmission information is input;
(S402) the forward propagation of the first artificial intelligence model AE1 generates the simulation output data ô₁;
(S403) the forward propagation of the second artificial intelligence model AE2 generates the prediction deployment information ô₂;
(S404) whether the prediction deployment information ô₂ meets a prediction performance threshold is evaluated according to the third actual transmission information, wherein if the prediction deployment information meets the prediction performance threshold, step (S405) is performed, and if the prediction deployment information does not meet the prediction performance threshold, step (S406) is performed;
(S405) the signal path redistributors 6 are deployed according to the prediction deployment information ô₂;
(S406) the step of generating, by the simulation unit 2, the first simulation information o₁ and the step of training the second simulation information o₂ are re-performed, and the steps of offline training, deployment prediction and online execution by the deployment unit 3 are performed.

In summary, the invention realizes the deployment of the dynamic signal path redistributor 6 through the domain conversion technology driven by real data (first actual transmission information xᵢₙ), bringing multiple economic benefits to telecommunication operators, equipment manufacturers and the communication industry. First of all, the invention can significantly reduce the cost of deploying dense small base stations for fifth generation communications (5G). Only a low-cost signal path redistributor 6 can improve signal coverage and improve communication quality. At the same time, the invention is compatible with existing communication protocols and does not require additional adjustments. Deployment through the automatic signal path redistributor 6 reduces the demand for human resources, and enables potential large-scale deployment operations to be completed with the help of the simulation unit 2 and the deployment unit 3. In addition, the invention can automatically determine the dynamic number of the signal path redistributors 6 to be deployed in the communication environment, and only needs to collect data when no signal path redistributors 6 are deployed, thereby saving time and cost for data collection.

Furthermore, the simulation unit 2 and the deployment unit 3 are flexible and can adapt to different environments, configurations and use cases. For example, during off-peak hours or in high-interference areas, some millimeter wave base stations can be turned off, and the deployment of the signal path redistributor 6 can replace some of the functions of the base station 4, thereby saving electricity costs. Finally, the application scope of the signal path redistributor 6 can be extended to smart services, networks, and multiple accesses of multiple spectrums, such as smart warehouses, private networks, WiFi deployments, and wireless resource management, providing flexible solutions for different scenarios.

The above description is only to illustrate the preferred implementation mode of the invention, and is not intended to limit the scope of implementation. All simple replacements and equivalent changes made according to the patent scope of the invention and the content of the patent specification all belong to the scope of the patent application of the invention.

What is claimed is:

1. An automatic deployment system, comprising:
an input unit, receiving a first actual transmission information and a second actual transmission information in a communication environment without signal path redistributor;
a simulation unit, connected to the input unit, the simulation unit receiving a plurality of simulation parameters and simulating to generate a first simulation information and a second simulation information according to the plurality of simulation parameters; and
a deployment unit, connected to the simulation unit and the input unit, the deployment unit training to generate a prediction deployment model according to the first actual transmission information, the first simulation information, and the second simulation information and using the prediction deployment model to generate a prediction deployment information according to the second actual transmission information.

2. The automatic deployment system according to claim 1, wherein the deployment unit is provided with a simulation performance threshold; after the deployment unit generates the prediction deployment information, the deployment unit compares a performance of the prediction deployment information with the simulation performance threshold; when the performance of the prediction deployment information meets the simulation performance threshold, the deployment unit publishes the prediction deployment information to a signal path redistributor in the communication environment; when the performance of the prediction deployment information does not meet the simulation performance threshold, the plurality of simulation parameters are adjusted to regenerate a new prediction deployment information.

3. The automatic deployment system according to claim 1, wherein the deployment unit is provided with an actual performance threshold; after the deployment unit publishes the prediction deployment information to a signal path redistributor in the communication environment, the deployment unit receives a third actual transmission information responded by a user device in the communication environment after the signal path redistributor is deployed at the position, and the deployment unit compares a performance of the third actual transmission information with the actual performance threshold; when the performance of the third actual transmission information meets the actual performance threshold, a deployment is completed; when the performance of the third actual transmission information does not meet the actual performance threshold, the deployment is not completed, and the plurality of simulation parameters are adjusted to regenerate a new prediction deployment information.

4. The automatic deployment system according to claim 1, wherein the communication environment further comprises a base station and a user device, and the simulation unit generates the first simulation information by simulating a state in which only the base station and the user device are present in the communication environment; the first simulation information comprises a first simulation wireless channel and a first simulation transmission performance; the simulation unit simulates each channel for transmitting wireless data between the base station and the user device as the first simulation wireless channel, and the simulation unit simulates transmission performance in each of the first simulation wireless channels as the first simulation transmission performance.

5. The automatic deployment system according to claim 4, wherein the simulation unit generates the second simulation information in a state where the communication environment comprises the base station, the user device, and a signal path redistributor; the second simulation information comprises a second simulation wireless channel and a second simulation transmission performance; the simulation unit simulates each channel for transmitting wireless data between the base station and the signal path redistributor, between the user device and the signal path redistributor, and between the signal path redistributor and another signal path redistributor as the second simulation wireless channel, and the simulation unit simulates transmission performance in each of the second simulation wireless channels as the second simulation transmission performance.

6. The automatic deployment system according to claim 5, wherein the deployment unit comprises a first artificial intelligence model and a second artificial intelligence model; the deployment unit receives the first actual transmission information or the second actual transmission information, processes the first actual transmission information, the first simulation information, and the second simulation information via the first artificial intelligence model and the second artificial intelligence model to generate the prediction deployment model, and provides the second actual transmission information to the prediction deployment model to generate the prediction deployment information.

7. The automatic deployment system according to claim 6, wherein the first artificial intelligence model generates a simulation output data according to the first actual transmission information and the first simulation information, and the second artificial intelligence model generates the prediction deployment information according to the simulation output data and the second simulation information.

8. The automatic deployment system according to claim 7, wherein the first artificial intelligence model and the second artificial intelligence model are both autoencoder models, the first artificial intelligence model comprises a first encoder and a first decoder, and the first encoder and the first decoder are both composed of neurons; the first encoder receives the first actual transmission information and generates a first latent variable according to the first actual transmission information and the first simulation information, and the first decoder receives the first latent variable and generates the simulation output data according to the first latent variable as an input of the second artificial intelligence model.

9. The automatic deployment system according to claim 8, wherein the first latent variable and the simulation output data are respectively expressed by the following formula:
$${v}_{1} = {f}_{ENC 1} ( {x}_{in} ; {θ}_{ENC 1} )$$
$${\hat{o}}_{1} = {f}_{DEC 1} ( {v}_{1} ; {θ}_{DEC 1} )$$
wherein v₁ represents the first latent variable, ô₁ represents the simulation output data, θ_{ENC1} and θ_{DEC1} are the model weights of the first encoder and the first decoder respectively, f_{ENC1}(xᵢₙ;θ_{ENC1}) is a function form in which the first actual transmission information is encoded, f_{DEC1}(v₁;θ_{DEC1}) is a function form in which the first latent variable is a reconstructed output, and xᵢₙ represents the first actual transmission information.

10. The automatic deployment system according to claim 9, wherein for the first encoder, the higher the layer, the fewer neurons there are, and the lower the layer, the more neurons there are; for the first decoder, the lower the layer, the fewer neurons there are, and the higher the layer, the more neurons there are; the number of neurons in the last layer of the first encoder is the same as the number of neurons in the first layer of the first decoder, and the number of neurons in the first layer of the first encoder is the same as the number of neurons in the last layer of the first decoder; each of the neurons represents a weight, and all neurons constitute the model weight of the first encoder; the relationship between the layers of the first encoder is shown in the following formula:
$${y}_{t + 1} = {f}_{act} ( {W}_{t} {x}_{t} + {b}_{t} )$$
wherein yₜ₊₁ represents the output of t+1 layers, xₜ represents the input of tth layer, Wₜ is the model weight of tth layer, bₜ is the bias weight of tth layer, f_{act} is the nonlinear activation function, and t is a positive integer.

11. The automatic deployment system according to claim 9, wherein a first loss function of the first artificial intelligence model may be designed according to the following formula:
$${L}_{1} = {\sum }_{i} {( {\hat{o}}_{1 , i} - {o}_{1 , i} )}^{2}$$
wherein i represents the index of nth output, L₁ represents the first loss function, and ô_{1,i}−ô_{1,i} represents the difference between the simulation output data and the first simulation information.

12. The automatic deployment system according to claim 9, wherein the second artificial intelligence model comprises a second encoder and a second decoder; a data sequence of the second simulation information input into the second encoder is the same as a data sequence of the simulation output data output by the first artificial intelligence model, and the second encoder and the second decoder have the same number of sequence units; each of the sequence units is a neural network unit, and the output of the second encoder is a second latent variable, which is expressed by the following formula:
$${v}_{2} = {f}_{ENC 2} ( {\hat{o}}_{1} ; {θ}_{ENC 2} )$$
wherein f_{ENC2} is the mapping function, the input of f_{ENC2} is the simulation output data ô₁, v₂ represents the second latent variable, θ_{ENC2} is a model weight of the second encoder, the second latent variable v₂ is the input of the second decoder, and ô₁ represents the simulation output data.

13. The automatic deployment system according to claim 12, wherein the second decoder comprises a start tag <SOS> and an end tag <EOS>, which respectively indicate the start and the end of the sequence; a prediction deployment data of each of the signal path redistributors is embedded between the start tag <SOS> and the end tag <EOS> in the form of {<SOS>, <Data1>, <Data2>, . . . <Data N>, <EOS>} to dynamically obtain the prediction deployment information by controlling the start tag <SOS> and the end tag <EOS>; the prediction deployment information may be expressed as {<SOS>, <deployment of SPR 1>, <deployment of SPR 2>, . . . <deployment of SPR N>, <system performance 1>, <system performance 2>, . . . <system performance N>, <EOS>}, wherein N may be a dynamic number and a positive integer, and the prediction deployment information comprises all the prediction deployment data.

14. The automatic deployment system according to claim 13, wherein in the communication environment, positions, orientations and heights of each base station, each user device, and each signal path redistributor are defined by Cartesian coordinates, as shown in the following formula:
$${X}_{n}^{SPR} ( {x}_{n}^{SPR} , {y}_{n}^{SPR} , {h}_{n}^{SPR} , {ϑ}_{n}^{SPR} , {φ}_{n}^{SPR} )$$
$${X}_{k}^{UE} ( {x}_{k}^{UE} , {y}_{k}^{UE} , {h}_{k}^{UE} , {ϑ}_{k}^{UE} , {φ}_{k}^{UE} )$$
$${X}_{l}^{BS} ( {x}_{l}^{BS} , {y}_{l}^{BS} , {h}_{l}^{BS} , {ϑ}_{l}^{BS} , {φ}_{l}^{BS} )$$
wherein n, k, l is a positive integer, SPR represents the signal path redistributor, UE represents the user device, BS represents the base station,
$${X}_{n}^{SPR}$$
is nth signal path redistributor,
$${x}_{n}^{SPR}$$
is the coordinate value of the nth signal path redistributor in the x axial direction,
$${y}_{n}^{SPR}$$
is the coordinate value of the nth signal path redistributor in the y axial direction,
$${h}_{n}^{SPR}$$
is the coordinate value of the nth signal path redistributor in the z axial direction,
$${ϑ}_{n}^{SPR}$$
is the horizontal angle of the nth signal path redistributor,
$${φ}_{n}^{SPR}$$
is the pitch angle of the nth signal path redistributor,
$${X}_{k}^{UE}$$
is the kth user device,
$${x}_{k}^{UE}$$
is the coordinate value of kth user device in the x axial direction,
$${y}_{k}^{UE}$$
is the coordinate value of kth user device in the y axial direction,
$${h}_{k}^{UE}$$
is the coordinate value of kth user device in the z axial direction,
$${ϑ}_{k}^{UE}$$
is the horizontal angle of the kth user device,
$${φ}_{k}^{UE}$$
is the pitch angle of the kth user device,
$${X}_{l}^{BS}$$
is lth base station,
$${x}_{l}^{BS}$$
is the coordinate value of the lth base station in the x axial direction,
$${y}_{l}^{BS}$$
is the coordinate value of the lth base station in the y axial direction,
$${h}_{l}^{BS}$$
is the coordinate value of the lth base station in the z axial direction,
$${ϑ}_{l}^{BS}$$
is the horizontal angle of the lth base station, and
$${φ}_{l}^{BS}$$
is the pitch angle of the lth base station;
the <deployment of SPR 1>, <deployment of SPR 2>, . . . <deployment of SPR N> in the prediction deployment information comprise the corresponding position of the signal path redistributor, which is expressed as
$${x}_{n}^{SPR} , {y}_{n}^{SPR} , {h}_{n}^{SPR} ,$$
the direction of the signal path redistributor, which is expressed as
$${ϑ}_{n}^{SPR} , {φ}_{n}^{SPR} ,$$
and the phase shift matrix of the signal path redistributor, which is expressed as redistributor; the phase shift matrix of the signal path redistributor is shown as the following formula:
$${Θ}_{n} = [ \begin{matrix}{β}_{n , 1} {e}^{j {ϕ}_{n , 1}} & 0 & … & 0 \\ 0 & {β}_{n , 2} {e}^{j {ϕ}_{n , 2}} & & ⋮ \\ ⋮ & & ⋱ & 0 \\ 0 & … & 0 & {β}_{n , M} {e}^{j {ϕ}_{n , M}}\end{matrix} ]$$
wherein Θₙ represents the phase shift matrix of the nth signal path redistributor, M represents the nth reflection unit of the signal path redistributor, 0≤β_{n,M}≤1 is the amplitude constraint of the nth reflection unit of the signal path redistributor, and 0≤φ_{n,M}≤2π is the phase constraint of the nth reflection unit of the signal path redistributor.

15. The automatic deployment system according to claim 14, wherein an output of the ith sequence in the sequence of the second decoder may be obtained through the previous layer (i.e., (i−1)th layer) of the lth sequence, and each of the sequences is a neuron layer and is expressed by the following formula:
$${seq}_{i} = {f}_{DEC 2 , i} ( {seq}_{i - 1} ; {θ}_{DEC 2 , i} )$$
wherein θ_{DEC2,i} is the model weight of the ith sequence, f_{DEC2,i} represents the function of the ith neural network unit layer of the second decoder DEC2, seqᵢ represents the output of the ith sequence, and i is a positive integer.

16. The automatic deployment system according to claim 15, wherein an input of the first sequence of the second decoder is the second latent variable v₂, and under the condition that a sequence length of the second decoder is V, and V is a positive integer, the prediction deployment information of the second decoder is expressed by the following formula:
$${\hat{o}}_{2} = [ {seq}_{v} , … , {seq}_{v - 1} , … {seq}_{2} , {seq}_{1} ]$$
wherein ô₂ represents the prediction deployment information, and v represents the index of the sequence and is a positive integer from 1 to V.

17. The automatic deployment system according to claim 16, wherein a third actual transmission information and the prediction deployment information in each of the sequence units use a second loss function to measure an error between the third actual transmission information and the prediction deployment information, and the second loss function is shown in the following formula:
$${L}_{2} = - {\sum }_{v = 1}^{V} {p}_{DEC 2 , v} log ( {\hat{p}}_{DEC 2 , v} )$$
wherein L₂ represents the second loss function, p_{DEC2,v} and \hat{p}_{DEC2,v} are the vth third actual transmission information and the prediction deployment information respectively, and the third actual transmission information is collected through exhaustive search.

18. The automatic deployment system according to claim 17, wherein the first artificial intelligence model performs back propagation to update a first neural network weight, as shown in the following formula:
$${θ}_{1} ← {θ}_{1} - η \cdot {∇}_{{θ}_{1}} {L}_{1}$$
wherein θ₁ is the first neural network weight of the first encoder and the first decoder of the first artificial intelligence model and comprises a first weight parameter W₁ and a first bias parameter b₁, and the first weight parameter and the first bias parameter are optimized during the training process to minimize the first loss function; η: a learning rate is a hyperparameter that determines a step size of each update of the first weight parameter and the first bias parameter of the first artificial intelligence model, and controls a distance that the first artificial intelligence model should move each time a gradient descends; ∇₇₄ L₁: a gradient of the first loss function with respect to the first neural network weight of the first artificial intelligence model represents a direction and a rate of change of the first loss function when the first weight parameter and the first bias parameter change.

19. The automatic deployment system according to claim 17, wherein the second artificial intelligence model performs back propagation to update a second neural network weight, as shown in the following formula:
$${θ}_{2} ← {θ}_{2} - η \cdot {∇}_{θ} {L}_{2}$$
wherein θ₂ is the second neural network weight of the second artificial intelligence model and comprises a second weight parameter and a second bias parameter of the second encoder and the second decoder, and the second weight parameter and the second bias parameter are optimized during the training process to minimize the second loss function L₂; η: a learning rate is a hyperparameter that determines a step size of each update of the second weight parameter and the second bias parameter of the second artificial intelligence model, and controls a distance that the second artificial intelligence model should move each time a gradient descends; ∇₇₄ L₂: a gradient of the second loss function with respect to a gradient of the second neural network weight of the second artificial intelligence model represents a direction and a rate of change of the second loss function when the second weight parameter and the second bias parameter change.

20. An automatic deployment method, applied to an automatic deployment system, the automatic deployment system comprising an input unit, a simulation unit and a deployment unit, the automatic deployment method comprising steps of:
receiving, by the input unit, a first actual transmission information in a communication environment without signal path redistributor;
receiving, by the simulation unit, a plurality of simulation parameters;
simulating, by the simulation unit, to generate a first simulation information and a second simulation information according to the plurality of simulation parameters;
training, by the deployment unit, to generate a prediction deployment model according to the first actual transmission information, the first simulation information, and the second simulation information and using the prediction deployment model to generate a prediction deployment information according to a second actual transmission information received by the input unit;
publishing, by the deployment unit, the prediction deployment information to a signal path redistributor in the communication environment.

21. The automatic deployment method according to claim 20, wherein the deployment unit is provided with a simulation performance threshold, and after the step of using the prediction deployment model to generate a prediction deployment information according to a second actual transmission information, the method further comprises steps of:
comparing, by the deployment unit, a performance of the prediction deployment information with the simulation performance threshold;
publishing, by the deployment unit, the prediction deployment information again to the signal path redistributor in the communication environment when the performance of the prediction deployment information meets the simulation performance threshold;
adjusting the plurality of simulation parameters to regenerate the new prediction deployment information when the performance of the prediction deployment information does not meet the simulation performance threshold.

22. The automatic deployment method according to claim 20, wherein the deployment unit is provided with an actual performance threshold, and after the step of publishing, by the deployment unit, the prediction deployment information to a signal path redistributor in the communication environment, the method further comprises steps of:
receiving, by the deployment unit, a third actual transmission information responded by the signal path redistributor at a deployment position through exhaustive search, and comparing, by the deployment unit, a performance of the third actual transmission information with the actual performance threshold;
indicating that the deployment is completed when the performance of the third actual transmission information meets the actual performance threshold;
indicating that the deployment is not completed when the performance of the third actual transmission information does not meet the actual performance threshold;
adjusting, by the simulation unit, the plurality of simulation parameters, and simulating to generate an adjusted first simulation information and an adjusted second simulation information according to the plurality of simulation parameters that is adjusted;
training, by the deployment unit, to generate an adjusted prediction deployment model according to the first actual transmission information, the adjusted first simulation information, and the adjusted second simulation information;
using the adjusted prediction deployment model to generate an adjusted prediction deployment information according to the second actual transmission information received by the input unit;
publishing, by the deployment unit, the adjusted prediction deployment information;
repeating the above steps until the performance of the third actual transmission information meets the actual performance threshold.

23. The automatic deployment method according to claim 20, wherein the step of receiving, by the simulation unit, the plurality of simulation parameters and simulating to generate a first simulation information and a second simulation information further comprise steps of:
setting the number of the signal path redistributors, wherein the number of the signal path redistributors deployed in the communication environment does not exceed the number of the signal path redistributors available;
setting a reference point position and calculating a direction and a height, comprising setting the reference point positions of all base stations and all user devices in the communication environment in the absence of the signal path redistributor, and setting the reference point positions of all the base stations and all the user devices in the communication environment when there are the signal path redistributors;
setting and collecting a dataset format, wherein the dataset format may be each of the reference point positions and a corresponding performance thereof, and wherein the reference point position, the direction and the height of the base station, the user device, and the signal path redistributor in the communication environment are respectively expressed by the following three formulas:
$${X}_{n}^{SPR} ( {x}_{n}^{SPR} , {y}_{n}^{SPR} , {h}_{n}^{SPR} , {ϑ}_{n}^{SPR} , {φ}_{n}^{SPR} )$$
$${X}_{k}^{UE} ( {x}_{k}^{UE} , {y}_{k}^{UE} , {h}_{k}^{UE} , {ϑ}_{k}^{UE} , {φ}_{k}^{UE} )$$
$${X}_{l}^{BS} ( {x}_{l}^{BS} , {y}_{l}^{BS} , {h}_{l}^{BS} , {ϑ}_{l}^{BS} , {φ}_{l}^{BS} )$$
wherein n, k, l is a positive integer, SPR represents the signal path redistributor, UE represents the user device, BS represents the base station,
$${X}_{n}^{SPR}$$
is nth signal path redistributor,
$${x}_{n}^{SPR}$$
is the coordinate value of the nth signal path redistributor in the x axial direction,
$${h}_{n}^{SPR}$$
is the coordinate value of the nth signal path redistributor in the y axial direction,
$${y}_{n}^{SPR}$$
is the coordinate value of the nth signal path redistributor in the z axial direction,
$${ϑ}_{n}^{SPR}$$
is the horizontal angle of the nth signal path redistributor,
$${φ}_{n}^{SPR}$$
is the pitch angle of the nth signal path redistributor,
$${X}_{k}^{UE}$$
is the kth user device,
$${x}_{k}^{UE}$$
is the coordinate value of kth user device in the x axial direction,
$${y}_{k}^{UE}$$
is the coordinate value of kth user device in the y axial direction,
$${h}_{k}^{UE}$$
is the coordinate value of kth user device in the z axial direction,
$${ϑ}_{k}^{UE}$$
is the horizontal angle of the kth user device,
$${φ}_{k}^{UE}$$
is the pitch angle of the kth user device,
$${φ}_{k}^{UE}$$
is lth base station,
$${x}_{l}^{bs}$$
is the coordinate value of the lth base station in the x axial direction,
$${y}_{l}^{BS}$$
is the coordinate value of the lth base station in the y axial direction,
$${h}_{l}^{BS}$$
is the coordinate value of the lth base station in the z axial direction,
$${ϑ}_{l}^{BS}$$
is the horizontal angle of the lth base station, and
$${φ}_{l}^{BS}$$
is the pitch angle of the lth base station.
calculating all distances, a probability of a line-of-sight path and an antenna array response between the base station and the signal path redistributor, between the signal path redistributor and the user device, between the base station and the user device, between the signal path redistributor and another signal path redistributor;
setting a cluster and a dispersion of a non-line-of-sight path, and calculating a channel response between the base station, the signal path redistributor, and the user device and the cluster;
calculating all values of a path loss and a penetration loss for each link between the line-of-sight path and the non-line-of-sight path;
obtaining a channel parameter of each link, wherein the channel parameter comprises a first indirect channel, a second indirect channel, and a direct channel or a mutual channel, the first indirect channel representing a channel between the base station and the signal path redistributor, the second indirect channel representing a channel between the signal path redistributor and the user device, the direct channel representing a channel between the base station and the user device, the mutual channel representing a channel between the signal path redistributor and the another signal path redistributor, a relationship between the channels being expressed by the following three formulas:
$$\begin{matrix}H = {P}_{LoS} {H}_{LoS} + {P}_{NLoS} {H}_{NLoS} \\ {H}_{LoS}^{a - b} = \sqrt{A ( {ϑ}^{a - b} , {φ}^{a - b} ) \cdot {PL}^{a - b} {L}_{mat}^{a - b}} \cdot a ( {ϑ}^{x} , {φ}^{x} ) {a}^{T} ( {ϑ}^{y} , {φ}^{y} ) \\ {H}_{NLoS}^{a - b} = {\sum }_{c = 1}^{C} {\sum }_{s = 1}^{{S}_{c}} {ε}_{c , s} \sqrt{A ( {ϑ}_{c , s}^{a - b} , {φ}_{c , s}^{a - b} ) \cdot {PL}_{c , s}^{a - b} {L}_{c , s , mat}^{a - b}} \cdot a ( {ϑ}_{c , s}^{x} , {φ}_{c , s}^{x} ) {a}^{T} ( {ϑ}_{c , s}^{y} , {φ}_{c , s}^{y} )\end{matrix}$$
wherein H is the general formula of the channel, P_{LoS} represents the line-of-sight path, P_{NLoS} represents the probability of the non-line-of-sight path, PL^{a-b} is the propagation loss and the penetration loss that depend on the transmission distance and application scenarios defined in the 3GPP 38.901 specification document,
$${L}_{maf}^{a - b}$$
is the material penetration loss depending on the object material, A(ε^{a-b},φ^{a-b}) is the predefined antenna pattern, a(ϑ^{x},φ^{x}) represents the array response vector, a^{T}(ϑ^{y},φ^{y}) is the transpose of the array response vector, and the superscript {x, y} depends on the node of the departure point and the node of the arrival point; wherein the {x, y} path has C NLoS clusters, each of the NLoS clusters has S_{c} dispersion at
$$( {H}_{NLoS}^{a - b} ) ,$$
and the crowd of each of the
$${H}_{NLoS}^{a - b}$$
clusters and the gain of the scattered
$${H}_{NLoS}^{a - b}$$
complex path are normalized to be defined as ε_{c,s};
the phase shift matrix of the signal path redistributor is shown as the following formulas:
$${Θ}_{n} = [ \begin{matrix}{β}_{n , 1} {e}^{j {ϕ}_{n , 1}} & 0 & … & 0 \\ 0 & {β}_{n , 2} {e}^{j {ϕ}_{n , 2}} & & ⋮ \\ ⋮ & & ⋱ & 0 \\ 0 & … & 0 & {β}_{n , M} {e}^{j {ϕ}_{n , M}}\end{matrix} ]$$
wherein Θₙ represents the phase shift matrix of the nth signal path redistributor, M represents the Mth reflection unit of the nth signal path redistributor, 0≤β_{n,M}≤1 is the amplitude constraint of the Mth reflection unit of the nth signal path redistributor, and 0≤φ_{n,M}≤2π is the phase constraint of the Mth reflection unit of the nth signal path redistributor;
using the following formula to calculate an effective channel between the lth base station and the kth user device, which is obtained by the sum of the direct channel from the lth base station to the kth user device and the second indirect path of the signal path redistributor with multiple reflections, as shown in the following formula:
$${H}_{l , k}^{eff} = {D}_{l . k} + {\sum }_{n = 1}^{N} {G}_{n , k} ( {\prod }_{i = 1}^{n - 1} {Θ}_{{v}_{i}} {Q}_{{v}_{i} {v}_{i + 1}} ) {Θ}_{{v}_{i}} {H}_{l , {v}_{1}}$$
wherein
$${H}_{l , k}^{eff}$$
represents the effective channel between the lth base station and the kth user device, D_{l,k} represent the channel gain of the direct channel between the lth base station and the kth user device,
$${\sum }_{n = 1}^{N}$$
represents the number of the signal path redistributors from the lth base station to kth user device and the channel gain of the second indirect channel between the nth signal path redistributor and the kth user device, Θᵥ_{ᵢ} represents the phase shift matrix of the vᵢth signal path redistributor, Qᵥ_{ᵢ}ᵥ_{ᵢ}₊₁ represents the channel gain of the mutual channel between the vᵢth signal path redistributor and the vᵢ₊₁th signal path redistributor, and H_{l,v}_{₁} represents the channel gain of the first indirect channel between the lth base station and the vᵢth signal path redistributor, the effective channel with 1 signal path redistributor being of the form D_{l,k}+G_{n,k}ΘₙH_{l,n}, while a channel with 2 signal path redistributor being of the form D_{l,k}+G_{n,k}ΘₙH_{l,n}+G_{n,k}ΘₙQ_{n′,n}Θₙ,H_{l,n′}, and so on;
generating a received signal model for base station, the signal path redistributor and the user device, and the received signal model from the lth base station to the kth user device is expressed by the following formula:
$${Y}_{l , k} = {H}_{l , k}^{eff} ( {X}_{l , k} + {\sum }_{{k}^{′} \neq k , k ∈ {K}_{l}}^{{K}_{l}} {X}_{l , {k}^{′}} ) + {\sum }_{i \neq l}^{L} {H}_{i , k}^{eff} {\sum }_{j ∈ {K}_{{i}^{′}}}^{{K}_{i}} {X}_{i , j} + {N}_{k}$$
wherein Y_{l,k} represents the received signal of kth user device transmitted by the lth base station, Nₖ represents the noise of the kth user device, the expected signal transmitted by the lth base station to the kth user device is expressed by X_{l,k}, X_{l,k′} represents the interference signal between the lth base station and other user devices,
$${\sum }_{i \neq l}^{L} {H}_{i , k}^{eff} {\sum }_{j ∈ {K}_{{i}^{′}}}^{{K}_{i}} {X}_{i , j}$$
represents the interference signal between the lth base station and other base stations, the lth base station is expressed by i, other base stations are expressed by j, Kₗ represents the set of all the user devices connected to the lth base station, Kᵢ represents the set of all the user devices of all other base stations connected to the ith base station;
evaluating performances of using the signal path redistributor in the communication environment and not using the signal path redistributor in the communication environment, while storing the performance of not using the signal path redistributor in the communication environment as the first simulation information;
checking whether a setting position of the signal path redistributor has been simulated and tested, and proceeding to, if not, steps of:
setting the signal path redistributor to a non-repeated position and repeating the steps of setting the reference point position and calculating the direction and the height to checking whether the setting position of the signal path redistributor has been simulated and tested to generate the second simulation information of all positions of the signal path redistributor;
when the setting position of the signal path redistributor has been checked to be simulated and tested, proceeding to steps of:
checking whether a performance of the second simulation information meets a simulation performance threshold;
when checking that the performance of the second simulation information meets the simulation performance threshold, storing the second simulation information currently completed, otherwise proceeding to the steps of:
checking the number of the signal path redistributors that may be deployed;
when checking that the number of the signal path redistributors that have been deployed is less than the number of the signal path redistributors that have been set to be deployed, increasing the number of the signal path redistributors that have been deployed and repeating the steps from setting the number of the signal path redistributors that have been set to be deployed to checking the number of the signal path redistributors that may be deployed;
when checking that the number of the signal path redistributors that have been deployed is equal to the number of the signal path redistributors that have been set to be deployed, storing the second simulation information with the best performance in the plurality of second simulation information collected previously as the second simulation information.

24. The automatic deployment method according to claim 23, wherein the deployment unit is divided into two parts: an offline training and an online execution.

25. The automatic deployment method according to claim 24, wherein the prediction deployment model comprises a first artificial intelligence model and a second artificial intelligence model; during the offline training, a step of simulating to generate a simulation output data by the deployment unit comprises:
using, by the deployment unit, the first actual transmission information and the first simulation information as an input data and an output data respectively;
constructing the first artificial intelligence model according to the following three formulas:
$$\begin{matrix}{v}_{1} = {f}_{ENC 1} ( {x}_{in} ; {θ}_{ENC 1} ) \\ {\hat{o}}_{1} = {f}_{DEC 1} ( {v}_{1} ; {θ}_{DEC 1} ) \\ {y}_{t + 1} = {f}_{act} ( {W}_{t} {x}_{t} + {b}_{t} )\end{matrix}$$
wherein v₁ represents a first latent variable, ô₁ represents the simulation output data, θ_{ENC1} and θ_{DEC1} are the model weights of a first encoder and a first decoder of the first artificial intelligence model respectively, xᵢₙ represents the first actual transmission information, yₜ₊₁ represents the output of t+1 layers, xₜ represents the input of the tth layer, Wₜ is the model weight of the tth layer, bₜ is the bias weight of the tth layer, and t is an positive integer;
setting the plurality of simulation parameters and providing to the first artificial intelligence model;
performing forward propagation in the first artificial intelligence model;
calculating a gradient of the first artificial intelligence model according to the first actual transmission information, the first simulation information, and a first loss function of the batch, the first loss function being shown as the following formula:
$${L}_{1} = {\sum }_{i} {( {\hat{o}}_{{1}_{i}} - {o}_{1 , i} )}^{2}$$
wherein i represents the index of the element and is a positive integer, L₁ represents the first loss function, and ô_{1,i}−o_{1,i} represents the difference between the simulation output data and the first simulation information;
performing back propagation according to the obtained gradient of the first artificial intelligence model to update the first neural network weight of the first artificial intelligence model, the formula of performing back propagation on the gradient of the first artificial intelligence model to update the first neural network weight being shown as follows:
$${θ}_{1} ← {θ}_{1} - η \cdot {∇}_{{θ}_{1}} {L}_{1}$$
wherein θ₁ is the first neural network weight of the first encoder and the first decoder of the first artificial intelligence model and comprises a first weight parameter W₁ and a first bias parameter b₁, and the first weight parameter and the first bias parameter are optimized during the training process to minimize the first loss function; η: a learning rate is a hyperparameter that determines a step size of each update of the first weight parameter and the first bias parameter of the first artificial intelligence model, and controls a distance that the first artificial intelligence model should move each time a gradient descends; η: a gradient of the first loss function with respect to the first neural network weight of the first artificial intelligence model represents a direction and a rate of change of the first loss function when the first weight parameter and the first bias parameter change;
obtaining, by the first artificial intelligence model, the first latent variable and the simulation output data;
determining whether the training is completed;
if the training is not completed, returning to the step of calculating the gradient of the neural network using the first actual transmission information, the first simulation information, and the first loss function of the batch to continue processing;
if the training is completed, storing the simulation output data and the first artificial intelligence model that has been trained.

26. The automatic deployment method according to claim 25, wherein the deployment unit, after the step of the offline training, performs a step of predicting deployment, and the step of predicting deployment uses a second artificial intelligence model to generate the prediction deployment information;
the simulation output data and the second simulation information are used as an input data sequence and an output data sequence respectively;
the second artificial intelligence model is constructed according to the following formula, and a second latent variable and the prediction deployment information are simulated and generated, the second artificial intelligence model comprising a second encoder and a second decoder:
$$\begin{matrix}{v}_{2} = {f}_{ENC 2} ( {\hat{o}}_{1} ; {θ}_{ENC 2} ) \\ {seq}_{i} \cdot = {f}_{DEC 2 , i} ( {seq}_{i - 1} ; {θ}_{DEC 2 , i} ) \\ {\hat{o}}_{2} = [ {seq}_{v} , … , {seq}_{v - 1} , … {seq}_{2} , {seq}_{1} ]\end{matrix}$$
wherein v₂ represents the second latent variable, f_{ENC2} is the mapping function, the input of f_{ENC2} is the simulation output data, θ_{ENC2} is the model weight of the second encoder, the second latent variable v₂ is the input of the second decoder, θ_{DEC2,i} is the model weight of the ith sequence, f_{DEC2,i} represents the function of the ith neural network unit layer of the second decoder, seqᵢ represents the output of the ith sequence, and ô₂ represents the prediction deployment information;
setting and providing the plurality of simulation parameters to the second artificial intelligence model;
performing forward propagation in the second artificial intelligence model;
calculating a gradient of the second artificial intelligence model according to the simulation output data, the third actual transmission information, and a second loss function of the batch, the second loss function being shown as the following formula:
$${L}_{2} = - {\sum }_{v = 1}^{V} {p}_{DEC 2 , v} log ( {p}_{DEC 2 , v} ) ;$$
wherein L₂ represents the second loss function, p_{DEC2,v} and \hat{p}_{DEC2,v} are a third actual transmission information of the vth deployment and the sequence index of the prediction deployment information respectively, and the third actual transmission information is collected through exhaustive search;
performing a second back propagation according to the obtained gradient of the second artificial intelligence model to update the model weight of the second artificial intelligence model, the second back propagation being shown as the following formula:
$${θ}_{2} ← {θ}_{2} - η \cdot {∇}_{{θ}_{2}} {L}_{2} ;$$
wherein θ₂ represents the model weight of the second artificial intelligence model, and the model weight of the second artificial intelligence model comprises weight parameters and bias parameter updates of the second encoder and the second decoder to minimize the second loss function; η represents the learning rate, which is a hyperparameter that determines the step size of each parameter update; ∇_{θ}L₂ represents the gradient of the second artificial intelligence model;
the second artificial intelligence model further uses the following formula to obtain the second latent variable and the prediction deployment information;
$$\begin{matrix}{v}_{2} = {f}_{ENC 2} ( {\hat{o}}_{1} ; {θ}_{ENC 2} ) \\ {seq}_{i} \cdot = {f}_{DEC 2 , i} ( {seq}_{i - 1} ; {θ}_{DEC 2 , i} ) \\ {\hat{o}}_{2} = [ {seq}_{v} , … , {seq}_{v - 1} , … {seq}_{2} , {seq}_{1} ]\end{matrix}$$
determining whether the second artificial intelligence model has been trained;
if the training is completed, storing the prediction deployment information ô₂ and the second artificial intelligence model that has been trained;
if the training is not completed, returning to the step of calculating a gradient of the second artificial intelligence model according to the simulation output data, the third actual transmission information and the second loss function of the batch.

27. The automatic deployment method according to claim 26, comprising, when the deployment unit is in the offline training, steps of:
inputting the second actual transmission information to the deployment unit;
generating, by forward propagation of the first artificial intelligence model, the simulation output data;
generating, by forward propagation of the second artificial intelligence model, the prediction deployment information;
evaluating, by the deployment unit, whether the prediction deployment information meets a prediction performance threshold according to the third actual transmission information;
publishing the prediction deployment information to the signal path redistributor when the deployment unit evaluates that the prediction deployment information meets the prediction performance threshold according to the first actual transmission information;
further re-performing the step of offline training and the step of predicting deployment of the deployment unit, and then re-performing the step of online execution step in addition to re-performing the step of generating, by the simulation unit, the first simulation information and the second simulation information when the deployment unit evaluates that the prediction deployment information does not meet the prediction performance threshold according to the first actual transmission information.
